(19) United States
(12) Patent Application Publication
(10) Pub. No.: US 2014/0019443 A1
(43) Pub. Date: Jan. 16, 2014

(54) Systems and methods for discovering content of predicted interest to a user

(71) Applicant: Venor, Inc., Mountain View, CA (US)

(72) Inventor: Ali Golshan, Santa Clara, CA (US)

(21) Appl. No.: 13/987,211

(22) Filed: Jul. 10, 2013

Related U.S. Application Data
(60) Provisional application No. 61/670,097, filed on Jul. 10, 2012.

(51) Int. Cl. G06F 17/30

(52) U.S. Cl. CPC G06F 17/3053
USPC 707/723

(57) ABSTRACT

A system comprising a communication interface configured to receive personal information of a user; a user characterization engine configured to determine a user interest of the user based on at least some of the personal information; an infuser configured to generate a search string based on the user interest; an infused crawler configured to retrieve one or more content elements from a network based on the search string; a content characterization engine configured to identify a context for each of the one or more content elements, and to assess for each of the one or more content elements a credibility score as to the respective context identified; a content selection engine configured to determine a probability score of each of the one or more content elements, the probability score being based on the user interest and the respective credibility score of each of the one or more content elements, the probability score defining a predicted interest of the user for each of the one or more content elements; and a content delivery engine configured to provide at least one of the one or more content elements to the user based on the one or more probability scores.

### PRIORITY CLAIM

This application claims benefit of and hereby incorporates by reference provisional patent application Ser. No. 61/670,097, entitled “System for Correlation of Internet Users Social Media and Other Private Network Data with Public Internet Information,” filed on Jul. 10, 2012, by inventor Ali Golshan.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments of the invention relate generally to computer networks, and more particularly include a system and method for discovering content of predicted interest to a user.

### BACKGROUND

The amount of information on the web continues to explode. The average user struggles to find timely and relevant information to fit their needs and/or interests. Information on the web that may interest users might include articles, documents, events, products, and special offers (e.g., discounts). Traditional search and other web tools struggle to deliver an efficient and accurate solution.

The typical approach to help users negotiate vast stores of information on the Internet consists of variations on a standard search. Standard search makes use of some form of relevance ranking. Relevance ranking, for example, may include indexes, weighted paths, or page rankings. Prior art search systems typically execute an undirected crawl through vast numbers of web sites for any content and index the information within that content to support quick response to previously unknown search queries. The prior art search system uses search terms of a search query to traverse the index to identify content that may be relevant.

Some search companies have refined relevance ranking of search results by incorporating one or more of the following enhancements:
Using search string word order to adjust the weightings applied to each word in the string of the search query used to search the index;
Consulting a list of recent trends and key words to weight more highly trendy key words of the search query;
Weighting a page (or content within the page) in order to increase the likelihood of providing the page to the user in response to the search query, the weighting of the page based on the number of other pages or websites that reference it; and
Requesting user reaction to random content to influence search results.

Traditional search, even with these enhancements, regularly fails to identify content of interest to the user. Word order does not necessarily translate to intended word importance. A user may not be searching for information on current trends. Content publishers can trick the system by adding page references elsewhere. Other pages may reference a site for its lack of value or relevance to an unrelated purpose. User reaction to random content poorly teaches the prior art search system a user's current interests (hobbies, needs, preferences, etc.) or intentions. User interest is difficult to guess.

### SUMMARY

At a high level, a discovery system discovers interests of a user as well as one or more ways the user wishes to receive and interact with information associated with their interests. Based on this information, the discovery system generates an information request and orders (prioritizes) retrieved information based, at least in part, on the user's interests and the way the user wishes to interact with the information. The discovery system may then provide all or some of the ordered information to the user in the form of a “Discovery”.

In various embodiments, a user may “opt in” to allow any amount of personal information to be shared with the discovery system. Personal information may include content the user consumed (e.g., read and/or searched for) as well as content the user produced (e.g., email, blog entries, tweets, social network updates, and/or text messages).

The discovery system may assess all personal information that the user shares with the discovery system to determine what is of interest to the user over time as well as to determine how the user interacts with consumed or produced content. For example, the discovery system may determine topics of interest as well the depth of articles for each interest read by the consumer (e.g., articles with dense fact patterns as opposed to articles with a high degree of superficiality). The discovery system may assess the consumed or produced content in any number of ways including, for example, based on sentiment (e.g., positive or negative; pro or con), intention of the content (e.g., intended messages), context, semantics, or the like. The discovery system may also assess how the user interacted with consumed or produced content including, for example, the length of time a user interacted with content and the speed the user reads portions of content (e.g., whether the user jumps over complex equations or jumps over Hollywood News).

Based on the assessment(s) of personal information shared by the discovery system over time, the discovery system may also generate an information request (e.g., a search query) for information that may be relevant to the user's interests. The discovery system may utilize the generated information request to retrieve information (e.g., over a network such as the Internet and/or from pre-storing data in a system corpus).

In some embodiments, the discovery system generates the information request to include not only topics of current interest of the user based on the user's consumption and production of content, but also the way the user interacts with the content (e.g., based on the assessment(s)). For example, the information request may be constructed to search for content that is at the depth the user typically produces or consumes related content. In some embodiments, the search request may be constructed to search for content that matches the preferred sentiment of the user for related content. Further, by assessing the user's personal information, the discovery system may identify not only the information that is relevant to the user's interest but also the intent of the user with respect to the information (e.g., the user intends to become skilled at cooking over gas and is looking for articles to assist in skill development). Those skilled in the art will appreciate that any, some, or all assessments of the user's “opted-in” personal information may be used to construct an information request for the user.

In some embodiments, a “content element” is a unit of user-readable content that the discovery system tracks and analyzes. For example, a content element may be a section of text as short as a phrase or as long as an entire document. A content element can be a phrase, a sentence, a paragraph, a section, an entire document, a subset of text, a blog entry, a web page, a Facebook post, a Twitter “tweet”, an event, an agenda for an event and/or the like.

In some embodiments, a “discovery” is the content determined to be of predicted interest to a user, which will be presented to the user. A discovery may include a content element, the source document containing the content element (e.g., the article in which the content element was found), a section of a document containing the content element, a set of content elements located in one or more sources, or the like.

The discovery system may order retrieved information based on the credibility of each content element of the retrieved information. In various embodiments, the discovery system may generate a credibility score for each content element. The credibility score may be based on how the content element is treated by others. Examples that influence the credibility score may include how often the content element is shared by others, whether the content element has been copied by others, region(s) (logical or geographical) where users share the content element with others, commentary about the content element, how far (logical or geographical) the content element been shared, and the like. The discovery system may score each retrieved content element for credibility and then prioritize the elements based on the credibility score.

Further, the discovery system may order the discoveries (e.g., content elements) from retrieved information based on the assessment(s). For example, discoveries may be ordered based on how well each item's depth, sentimentality, and/or intent matches with the depth, sentimentality and/or intent of related personal information of the user. In some embodiments, the discovery system may generate scores for “user depth,” “user sentimentality,” and “user intent” for each topic. The user depth, user sentimentality, and user intent for each topic may be based on an average of personal information (e.g., produced or consumed) related to that topic over a period of time. For example, the depth of articles the user consumed related to cooking over gas may be averaged or otherwise combined to generate a “user depth” for cooking over gas. Similar methods may be used to generate “user sentiment” and “user intent.” Those skilled in the art will appreciate that any individual assessment of content from a user's personal information may be used to characterize the user in a similar manner as discussed herein.

In various embodiments, the discovery system may order discoveries from retrieved information by comparing various authors to users. For example, the discovery system may identify any number of authors for each or any retrieved discoveries. Each author may be characterized based on the amount of content the author produced over a period of time that is related to the information that is retrieved. In some embodiments, an author may be associated with an “author depth,” “author sentiment,” and “author intent” for each topic (e.g., each area of the author's expertise). The “author depth” of an author may be an average of the depth determined for each article produced by the author that is related to the information request (in a manner similar to that discussed regarding user's personal information). Similar methods may be used to generate “author sentiment” and “author intent.” Those skilled in the art will appreciate that any individual assessment of content may be used to characterize the author in a similar manner as discussed herein.

Those skilled in the art will appreciate that discoveries may be ordered in any number of ways including, but not limited to, by credibility score, by comparing content element assessments to user characterizations (e.g., user depth, user sentiment, user intent), and/or by comparing authors of received discoveries to users (e.g., comparing author characterizations to user characterizations).

The delivery system may deliver one, some, or all retrieved discoveries (e.g., unordered or ordered) to the user. The delivery system may deliver discoveries in any number of ways including in response to a request by the user, in a web page personalized for the user, email, tweet, text message, or the like.

In some embodiments, a system comprises a communication interface configured to receive personal information of a user; a user characterization engine configured to determine a user interest of the user based on at least some of the personal information; an infuser configured to generate a search string based on the user interest; an infused crawler configured to retrieve one or more content elements from a network based on the search string; a content characterization engine configured to assess a credibility score for each of the one or more content elements; a content selection engine configured to determine a probability score of each of the one or more content elements, the probability score defining a predicted interest of the user for each of the one or more content elements, each probability score being based on the user interest and the respective credibility score of each of the one or more content elements; and a content delivery engine configured to provide at least one of the one or more content elements to the user based on the one or more probability scores.

The personal information may include private user data to which the user granted the system access. The content characterization engine may assess the credibility score of each of the one or more content elements by evaluating how other users responded to each of one or more content elements. The system may further comprise a knowledge management engine configured to store the user interest in a user profile for the user. The system may further comprise a knowledge management engine configured to store in a master profile information of the user interest, the one or more content elements, and the one or more credibility scores. The system may further comprise an author discovery and attribution engine configured to attribute an author to each of the one or more retrieved content elements; and an author characterization engine configured to determine a credibility score of each author as to the user interest; wherein the knowledge management engine is further configured to store the author credibility score of each author in the master profile. The content selection engine may determine the probability score by comparing sentiment, intention and/or depth of each of the retrieved one or more content elements against sentiment, intention and/or depth of the user as related to the user interest. The content selection engine may determine the probability score by comparing author information about each author of the retrieved one or more content elements against user information about the user. The system may further comprise a content decomposition engine configured to decompose web data into the one or more content elements based on author attribution.

In some embodiments, a method comprises receiving personal information of a user; determining a user interest of the user based on at least some of the personal information; generating a search string based on the user interest; retrieving one or more content elements from a network based on the search string; assessing a credibility score for each of the one or more content elements; determining a probability score of each of the one or more content elements, the probability score defining a predicted interest of the user for each of the one or more content elements, each probability score being based on the user interest and the respective credibility score of each of the one or more content elements; and providing at least one of the one or more content elements to the user based on the one or more probability scores.

The personal information may include private user data to which the user granted the system access. The assessing the credibility score of each of the one or more content elements may include evaluating how other users responded to each of one or more content elements. The method may further comprise storing the user interest in a user profile for the user. The method may further comprise storing information on the user interest, the one or more content elements, and the one or more credibility scores in a master profile. The method may further comprise attributing an author to each of the one or more retrieved content elements; determining a credibility score of each author as to the user interest; and storing the author credibility score of each author in the master profile. The determining the probability score may include comparing sentiment, intention and/or depth of each of the retrieved one or more content elements against sentiment, intention and/or depth of the user as related to the user interest. The determining the probability score may include comparing author information about each author of the retrieved one or more content elements against user information about the user. The method may further comprise decomposing a web site into the one or more content elements based on author attribution.

In some embodiments, a system comprises means for receiving personal information of a user; means for determining a user interest of the user based on at least some of the personal information; means for generating a search string based on the user interest; means for retrieving one or more content elements from a network based on the search string; means for assessing a credibility score for each of the one or more content elements; means for determining a probability score of each of the one or more content elements, the probability score defining a predicted interest of the user for each of the one or more content elements, each probability score being based on the user interest and the respective credibility score of each of the one or more content elements; and means for providing at least one of the one or more content elements to the user based on the one or more probability scores.

In some embodiments, a non-transitory computer-readable medium stores instructions executable by a processor to perform a method, the method comprising receiving personal information of a user; determining a user interest of the user based on at least some of the personal information; generating a search string based on the user interest; retrieving one or more content elements from a network based on the search string; assessing a credibility score for each of the one or more content elements; determining a probability score of each of the one or more content elements, the probability score defining a predicted interest of the user for each of the one or more content elements, each probability score being based on the user interest and the respective credibility score of each of the one or more content elements; and providing at least one of the one or more content elements to the user based on the one or more probability scores.

### BRIEF DESCRIPTION OF THE DRAWINGS

FIG. 1 is a diagram of an example network system for assisting in identifying public content elements of predicted interest to a user, the public content elements being publicly available on a computer network in some embodiments.

FIGS. 2a and 2b are a diagram illustrating details of the discovery system, in some embodiments.

FIG. 3 is a diagram illustrating additional details of the discovery system, in some embodiments.

FIG. 4a is a diagram illustrating details of the knowledge management engine, in some embodiments.

FIG. 4b is a diagram illustrating methods of various components of the knowledge management engine, in some embodiments.

FIG. 4c is a diagram illustrating methods of various additional components of the knowledge management engine, in some embodiments.

FIG. 5 is a diagram illustrating a method of creating MHRI and PHRIs, in some embodiments.

FIG. 6 is a diagram illustrating an example MHRI portion, in some embodiments.

FIG. 7 is a diagram illustrating details of an example PHRI portion, in some embodiments.

FIG. 8 is a diagram illustrating details of a user matrix, in some embodiments.

FIG. 9 is a diagram illustrating details of user data, in some embodiments.

FIG. 10 is a diagram illustrating details of an infuser method, in some embodiments.

FIG. 11 is a diagram illustrating details of an infused crawler method, in some embodiments.

FIG. 12 is a diagram illustrating additional details of an infused crawler method, in some embodiments.

FIG. 13 is a diagram illustrating details of content decomposition, content characterization, and author discovery and attribution methods, in some embodiments.

FIG. 14 is a diagram illustrating details of the content characterization method, in some embodiments.

FIG. 15 is a diagram illustrating details of the user characterization method, in some embodiments.

FIG. 16 is a diagram illustrating details of the dynamic curation method, in some embodiments.

FIG. 17a is a diagram illustrating details of the content selection method, in some embodiments.

FIG. 17b is a diagram illustrating additional details of the content selection method, in some embodiments.

FIG. 17c is a diagram illustrating additional details of the content selection engine, in some embodiments.

FIG. 18 is a block diagram illustrating details of an example digital device.

### DETAILED DESCRIPTION

The following description is provided to enable a person skilled in the art to make and use various embodiments of the invention. Modifications are possible. The generic principles defined herein may be applied to the disclosed and other embodiments without departing from the spirit and scope of the invention. Thus, the claims are not intended to be limited to the embodiments disclosed, but are to be accorded the widest scope consistent with the principles, features and teachings herein.

At a high level, a discovery system discovers interests of a user as well as one or more ways the user wishes to receive and interact with information associated with their interests. Based on this information, the discovery system generates an information request and orders (prioritizes) retrieved information based, at least in part, on the user's interests and the way the user wishes to interact with the information. The discovery system may then provide all or some of the ordered information to the user.

In various embodiments, a user may “opt in” to allow any amount of personal information to be shared with the discovery system. Personal information may include content the user consumed (e.g., read and/or searched for) as well as content the user produced (e.g., email, blog entries, tweets, social network updates, and/or text messages).

The discovery system may assess all personal information that the user shares with the discovery system to determine what is of interest to the user over time as well as to determine how the user interacts with consumed or produced content. For example, the discovery system may determine topics of interest as well the depth of articles for each interest read by the consumer (e.g., articles with dense fact patterns as opposed to articles with a high degree of superficiality). The discovery system may assess the consumed or produced content in any number of ways including, for example, based on sentiment (e.g., positive, negative or neutral; pro or con), intention of the content (e.g., intended messages), context, semantics, or the like. The discovery system may also assess how the user interacted with consumed or produced content including, for example, the length of time a user interacted with content and the speed the user reads portions of content (e.g., whether the user jumps over complex equations or jumps over Hollywood News).

Based on the assessment(s) of personal information shared with the discovery system over time, the discovery system may generate an information request (e.g., a search query) for information that may be relevant to the user's interests. The discovery system may utilize the generated information request to retrieve information (e.g., over a network such as the Internet and/or from pre-storing data in a system corpus).

In some embodiments, the discovery system generates the information request to include not only topics of current interest of the user based on the user's consumption and production of content, but also the way the user interacts with the content (e.g., based on the assessment(s)). For example, the information request may be constructed to search for content that is at the depth the user typically produces or consumes related content. In some embodiments, the search request may be constructed to search for content that matches the preferred sentiment of the user for related content. Further, by assessing the user's personal information, the discovery system may identify not only the information that is relevant to the user's interest but also the intent of the user with respect to the information (e.g., the user intends to become skilled at cooking over gas and is looking for articles to assist in skill development). Those skilled in the art will appreciate that any, some, or all assessments of the user's “opted-in” personal information may be used to construct an information request for the user.

In some embodiments, a “content element” is a unit of user-readable content that the discovery system tracks and analyzes. For example, a content element may be a section of text as short as a phrase or as long as an entire document. A content element can be a phrase, a sentence, a paragraph, a section, an entire document, a subset of text, a blog entry, a web page, a Facebook post, a Twitter “tweet”, an event, an agenda for an event and/or the like.

In some embodiments, a “discovery” is the content determined to be of predicted interest to a user, which will be presented to the user. A discovery may include a content element, the source document containing the content element (e.g., the article in which the content element was found), a section of a document containing the content element, a set of content elements located in one or more sources, or the like.

The discovery system may order retrieved information based on the credibility of each content element of the retrieved information. In various embodiments, the discovery system may generate a credibility score for each content element. The credibility score may be based on how the content element is treated by others. Examples that influence the credibility score may include how often the content element is shared by others, whether the content element has been copied by others, region(s) (logical or geographical) where users share the content element with others, commentary about the content element, how far (logical or geographical) the content element has been shared, and the like. The discovery system may score each retrieved content element for credibility and then prioritize the discoveries based on the credibility score.

Further, the discovery system may order the discoveries from retrieved information based on the assessment(s). For example, discoveries may be ordered based on how well each content element's depth, sentimentality, and/or intent matches with the depth, sentimentality and/or intent of related personal information of the user. In some embodiments, the discovery system may generate scores for “user depth,” “user sentimentality,” and “user intent” for each topic. The user depth, user sentimentality, and user intent for each topic may be based on an average of personal information (e.g., produced or consumed) related to that topic over a period of time. For example, the depth of articles the user consumed related to cooking over gas may be averaged or otherwise combined to generate a “user depth” for cooking over gas. Similar methods may be used to generate “user sentiment” and “user intent.” Those skilled in the art will appreciate that any individual assessment of content from a user's personal information may be used to characterize the user in a similar manner as discussed herein.

In various embodiments, the discovery system may order discoveries from retrieved information by comparing various authors to users. For example, the discovery system may identify any number of authors for each or any retrieved content elements. Each author may be characterized based on the amount of content the author produced over a period of time that is related to the information that is retrieved. In some embodiments, an author may be associated with an “author depth,” “author sentiment,” and “author intent” for each topic (e.g., each area of the author's expertise). The “author depth” of an author may be an average of the depth determined for each article produced by the author that is related to the information request (in a manner similar to that discussed regarding user's personal information). Similar methods may be used to generate “author sentiment” and “author intent.” Those skilled in the art will appreciate that any individual assessment of content may be used to characterize the author in a similar manner as discussed herein.

Those skilled in the art will appreciate that discoveries may be ordered in any number of ways including, but not limited to, by credibility score, by comparing content element assessments to user characterizations (e.g., user depth, user sentiment, user intent), and/or by comparing author(s) of received content elements to users (e.g., comparing author characterizations to user characterizations).

The delivery system may deliver one, some, or all retrieved discoveries (e.g., unordered or ordered content elements) to the user. The delivery system may deliver discoveries in any number of ways including in response to a request by the user, in a web page personalized for the user, email, tweet, text message, or the like.

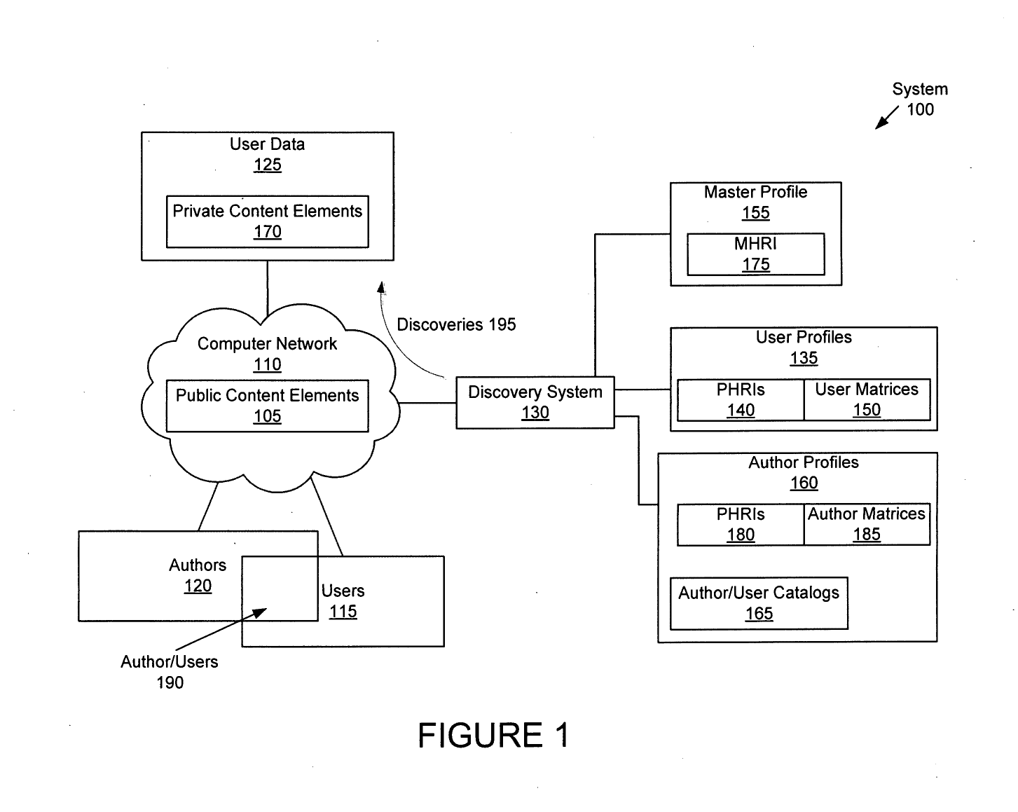

FIG. 1 is a diagram of an example network system 100 for assisting in identifying public content elements 105 of predicted interest to a user 115, the public content elements 105 being publicly available on a computer network 110 (e.g., the Internet) in some embodiments. Examples of public content elements 105 include documents, news, products, music, video clips, events (e.g., concerts, speeches, plays, movies, television shows, other entertainment or non-entertainment events), and special offers.

The network system 100 includes a discovery system 130 that identifies public content elements 105 of predicted interest to a user 115, based on the current interests of the user 115 and the current expertise of the authors 120 of the public content elements 105. “Interest” herein generally focuses on the perspective of a user 115, and “expertise” generally focuses on the perspective of an author 120. For example, a content element 105 may be thought of “interest” to a user 115, when the discovery system 130 has determined that the content element 105 is relevant subject matter associated with content the user has recently consumed (e.g., read) and/or produced (e.g., written about). Current interest on a given topic (e.g., information class) may be measured by scoring subject matter associated with a user's recent content production and/or consumption.

The discovery system 130 may determine that an author 120 has expertise on a topic after recognizing that the author 120 has published one or more public content elements 105 related to the topic, and possibly after recognizing that users 115 perceive the one or more public content elements 105 published by the author 120 as credible on that topic. Current expertise on a given topic (e.g., information class) may be measured by scoring an author or user's recent content production and possibly consumption, as well as the credibility of the author or user's recent production. Alternatively or additionally, in addition to having authored one or more public content elements 105 related to a topic, the discovery system 130 may determine that an author 120 has expertise after recognizing that the author 120 has an advanced degree involving that topic, has worked in a field involving that topic for a number of years, or the like.

In some embodiments, an “area of interest” (AOI) refers to a topic of interest to a user 115, in which that user 115 has shown a first threshold level of interest and/or knowledge. An “area of expertise” (AOE) refers to a topic of interest to a user 115 or author 120, in which that user 115 or author 120 has shown a second threshold (higher than the first threshold) level of interest and/or knowledge. That is, an AOI and an AOE may refer to different levels of interest and/or knowledge on the same scale. The scale defining level of interest and/or knowledge might break down as follows: 1) no interest, 2) casual interest, 3) an AOI, and 4) an AOE.

The discovery system 130 may learn about the current interests of a user 115 by examining user data 125 of the user 115 and possibly by examining public content elements 105 of which the user 115 is the author 120. The discovery system 130 may learn about the current expertise of an author 120 of public content elements 105 by examining the content of the public content elements 105 and possibly by examining the authors' user data 125 if the author 120 is also a user 115. It will be appreciated that the discovery system 130 may attribute many types of entities to represent the authorship of one or more public content elements 105. For example, the discovery system 130 can treat a brand, a corporation, an organization, a club, a government, a political party, an unknown entity, etc. as an “author” and may similarly assess content production for determination of AOE(s) associated with the “author.”

In some embodiments, user data 125 includes private content elements 170, which may include private user data (e.g., email, home address, calendar data, bookmarks, search history, music library, etc.) and/or semi-private user data (e.g., social media content, which can be seen by others only by invitation, social media friends, etc.). Although not shown, user data 125 may also include public user data (e.g., published articles or blog posts for which the user 115 is also the author 120). It will be appreciated that, when a user 115 is also an author 120 of public content elements 105, that user's user data 125 may include public content elements 105 that may be available for presentation to other users 115. User data 125 might also include identification of cohorts (and their connections), the geographic location of the user 115 and of each of the user's cohorts, the user's response time to various posts, the user's communication history with the user's cohorts, the social groups to which the user 115 belongs, the other members of the social groups, etc.

In some embodiments, the discovery system 130 applies natural language processing, statistical analysis, and machine learning techniques to examine the user data 125 of users 115 who allow the discovery system 130 to access their user data 125 (e.g., opt in or subscribe to the discovery system 130 to share personal information). From the user data 125, the discovery system 130 develops a user profile 135 for each user 115. In some embodiments, each user profile 135 includes a personal hierarchical reasoning index (PHRI) 140 and a user matrix 150. The PHRI 140 and user matrix 150 characterize a user's areas of interest (AOIs), areas of expertise (AOE), and sentiment, intentions, depth and credibility within each AOI and/or AOE. The user matrix 150 associates metadata with information collected from the information shared by the user (e.g., user's user data 125). The user matrix 150 may associate metadata with public content elements 105 presented to the user 115, searches requested, author correlations, past user behavior, weighting scores, stated preferences, etc. Development of the user profile 135 is discussed in more detail below.

In some embodiments, the discovery system 130 examines public content elements 105 in a similar way to that performed on user data 125. From the examination of the content elements 105, the discovery system 130 develops an author profile 160 for each author 120. The discovery system 130 selects a public content element 105, examines it, identifies its author 120, and creates an author profile 160 (similar or identical to a user profile 135) based on the examination. Sometimes, the author 120 of a public content element 105 will be immediately identifiable. Sometimes, the author 120 will subscribe as a user 115. When the author 120 is identifiable and subscribes as a user 115, the author profile 160 may be combined with that author's user profile 135. In some embodiments, the discovery system 130 may create both an author profile 160 and a user profile 135, which may or may not be the same. When the author 120 has not subscribed as a user 115 or when the author 120 is not identifiable (and thus the discovery system 130 is using an unidentified-author identifier), the author profile 160 may be based only on the public content elements 105, and not on any private or semi-private user data 125 of that author 120. One skilled in the art will recognize that, in some embodiments, the discovery system 130 may not distinguish between user profiles 135 and author profiles 160. In some embodiments, when the user 115 and the author 120 are the same entity, the author profile 160 may be dedicated to that entity's areas of expertise (AOE) and the user profile may be dedicated to that entity's areas of interest (AOI). Other combinations are possible.

The discovery system 130 assembles the user profiles 135 (to assist in predicting trends, items of mass interest, like-minded users 115, unlike-minded users 115, etc.), the author profiles 160 (to assist in identifying the areas of expertise and characteristics of authors 120), the public content elements 105 (to provide local store of content elements 105 for presentation to users 115), information classes and subclasses (to assist in organizing the content elements 105, user profiles 135 and author profiles 160 into hierarchical relationships), and the interrelationships among them into a master profile 155. In some embodiments, the master profile 155 may include or be associated with a multi-dimensional master hierarchical reasoning index (MHRI) 175. The discovery system 130 uses the master profile 155 and a user's user profiles 135 to assist with identifying public content elements 105 of predicted interest to a user 115.

In some embodiments, the discovery system 130 may discover public content elements 105 of predicted interest to a user 115 automatically (e.g., via a dynamically generated query) or in response to user request (e.g., via an express query). In some embodiments, in response to a query, the discovery system 130 identifies from the master profile 155 content elements 105 relevant to a topic of interest. Alternatively, the discovery system 130 may cooperate with a traditional search engine to identify content elements 105 relevant to the topic of interest.

In some embodiments, if the discovery system 130 identifies a vast number of relevant content elements 105, the discovery system 130 may evaluate the content elements 105 and/or metadata (e.g., sentiment, intention, depth and credibility) on the content elements 105 to generate a probability score defining the probable interest to the user 115. The discovery system 130 may select a set of the relevant content elements 105 based on the probability scores (e.g., those exceeding a threshold probability, such as 95%) to identify those relevant content elements 105 of sufficient probable interest to the user 115.

In some embodiments, if the discovery system 130 still identifies a vast number of relevant content elements of sufficient probable interest, the discovery system 130 may compare the user profile 135 of the requesting user 115 against the author profiles 160 of the content elements 105 of sufficient probable interest to identify commonalities (including differences) between a user 115 and particular authors 120. The discovery system 130 may generate likeness and/or unlikeness scores (generally referred to herein as “matching scores”) based on the commonalities. The discovery system 130 may also compare user profiles 135 against each other to identify commonalities between users 115 to generate matching scores to identify like-minded and/or unlike-minded users 115. Further, the discovery system 130 may compare author profiles 160 against each other to identify commonalities between authors 120 to generate matching scores to identify like-minded and/or unlike-minded authors 120. The discover system 130 uses the commonality results (e.g., matching scores) to assist with selecting a set of the relevant content elements 105 of sufficient probable interest to identify the content elements 105 of predicted interest to the user 115.

In some embodiments, as the user 115 is presented with discoveries 195 (e.g., content elements 105), the discovery system 130 reacts to feedback (e.g., curation behavior that indicates the user's actual likes and dislikes of the discoveries presented). The discovery system 130 may process the nature and speed of feedback to improve the quality and/or prioritization of future discoveries for that and other similar users 115. The discovery system 130 updates the master profile 155, the user profiles 135 and/or the author profiles 160.

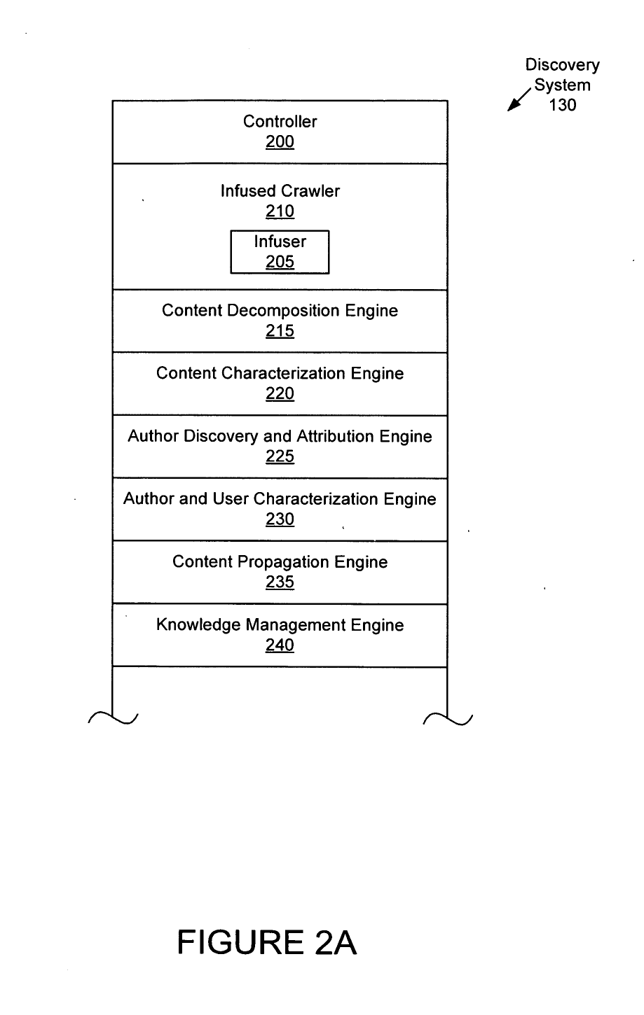

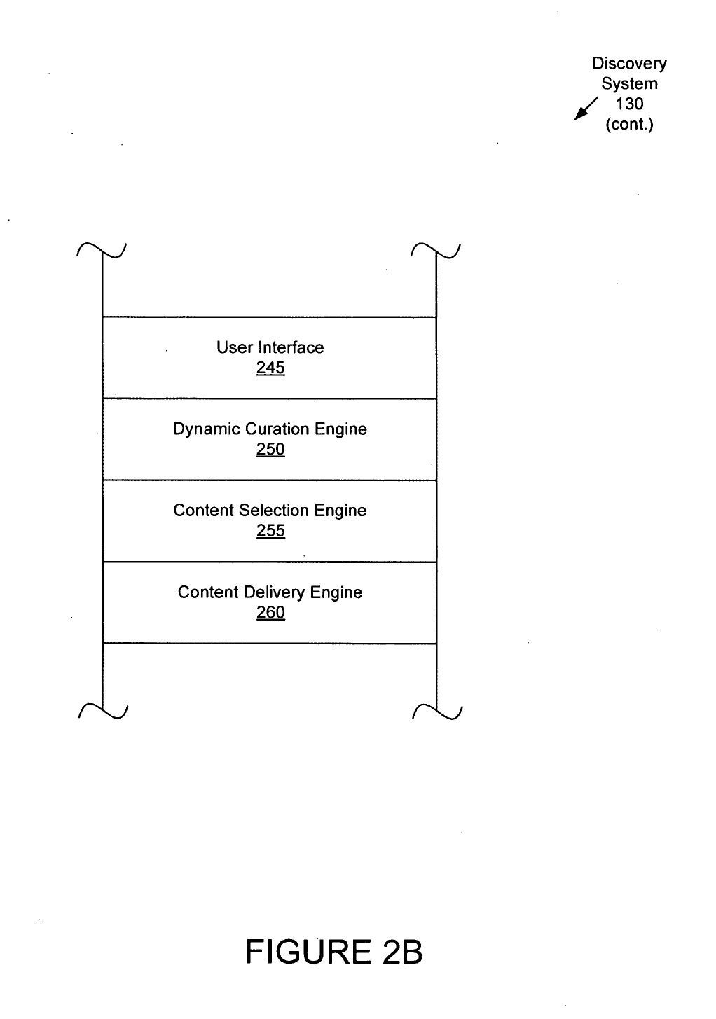

FIGS. 2a and 2b are a diagram illustrating details of the discovery system 130, in some embodiments. As depicted in FIG. 2a, the discovery system 130 includes a controller 200, an infuser 205, an infused crawler 210, a content decomposition engine 215, a content characterization engine 220, an author discovery and attribution engine 220, an author and user characterization engine 230, a content propagation engine 235, a knowledge management engine 240, a user interface 245, a dynamic curation engine 250, a content selection engine 255, and a content delivery engine 260.

The controller 200 is hardware, software and/or firmware that manages the operations of the discovery system 130, in some embodiments. The controller 200 controls the timing when one or more of the components of the discovery system 130 starts and ends the various procedures and/or services described herein.

The infuser 205 is hardware, software and/or firmware that cooperates with the knowledge management engine 240 to analyze the user profiles 135 and the master profile 155 to identify search criteria for the infused crawler 210. In some embodiments, the infuser 205 analyzes the user profiles 135 to assist in identifying current interests of one or more of the users 115. In some embodiments, after analyzing the user profiles 135 to identify areas of interest, the infuser 205 may analyze the master profile 155 (e.g., the MHRI 175) to determine whether the master profile 155 identifies sufficient content elements 105 to satisfy the interest. In some embodiments, the infuser 205 analyzes the master profile 155 to assist in identifying mass interest to many or most users 115 (such as hot topics or trends).

In response to identifying the user interest and recognition of an insufficient number and/or quality of content elements 105 in the master profile 155 to satisfy the interest, the infuser 205 builds filters for the infused crawler 210 to use to search the computer network 110 (e.g., the Internet) for public content elements 105 pertaining to the areas of interest. In some embodiments, the infuser 205 prioritizes the filters based on the number of users 115 having the interest, the level of interest, the amount of public content elements 105 already identified in the master profile 155 to satisfy the interest, feedback, user request, and/or the like.

Those skilled in the art will appreciate that the infuser 205 may generate an information request for the infused crawler 210. The information request may be any search query. In some embodiments, the infuser 205 will generate an information request for information related to topics of interest for one or more users. The information request may include search strings related to metadata stored in one or more user profile(s). For example, the information request may include information associated with the location of one or more users, time of day associated with the request (e.g., coffee shops open late at night), context, subtext, perspective, or the like. In some embodiments, filters are applied to the results received from the search of the infused crawler 210. In various embodiments, no filters are applied or utilized with either the information request or the results of the infused crawler 210.

The infused crawler 210 is hardware, software and/or firmware that uses the filters and/or information request from the infuser 205 to crawl the computer network 110 for public content elements 105. Those skilled in the art will appreciate that, in some embodiments, the infused crawler 210 crawls the computer network 110, such as the Internet, for additional information when information contained or associated with the master profile 155 (e.g., the MHRI 175) is insufficient to satisfy the filters and/or information request.

In some embodiments, the infused crawler 210 may use the filters in the priority order set by the infuser 205. In some embodiments, the infused crawler 210 may crawl through the computer network 110 without the use of filters. One skilled in the art will recognize that the discover system 130 could include many infused crawlers 210 operating with and/or without filters.

The content decomposition engine 215 is hardware, software and/or firmware that uses natural language processing, statistical analysis, and machine learning techniques to decompose public content (blogs, websites, articles, etc.) into content elements 105. In some embodiments, the content decomposition engine 215 cooperates with the content characterization engine 220, the author discovery and attribution engine 225, and/or the knowledge management engine 240. Public content may be itself a “content element” that is decomposed into content fragments (also circularly referred to as a “content element”). For example, a website can be a content element 105, and the website can contain multiple articles, each being a content element 105.

In some embodiments, the content decomposition engine 215 may decompose public content based on author attribution. That is, the content decomposition engine 215 may partition public content so that each content element 105 can be attributed to a single author 120. For example, the content decomposition engine 215 may decompose a website that contains blog entries of multiple authors 120 into individual blog entries, so that each blog entry can be attributed to its corresponding author 120.

The content decomposition engine 215 may also decompose public content based on information classes, so that each public content element 105 can be attributed to single class of information (e.g., topic or subtopic). For example, the content decomposition engine 215 may be tasked to decompose a news website for a news reporting company, “NewsCo,” that contains sections dealing with sports, politics, and entertainment. The content decomposition engine 215 may detect the differing classes in the different sections and therefore decompose the NewsCo website into separate content elements 105, e.g., NewsCo sports, NewsCo politics, and NewsCo entertainment.

The following items may be content elements 105 that decompose further into content fragments:
an article
document
a music album
an event or the agenda for an event
a presentation
an audio or video file
many other forms of content

In a similar way, the content decomposition engine 215 may use natural language processing, statistical analysis, and machine learning techniques to decompose user data 125 into multiple private content elements 170. In some embodiments, the content decomposition engine 215 may decompose the user data 125 based on “author” attribution. For example, the content decomposition engine 215 may decompose a user's email into parts written by the user 115 and parts written by the user's friends. In some embodiments, the content decomposition engine 215 may decompose the user data 125 based on information classes, so that each private content element 170 can be attributed to a single information class. For example, the content decomposition engine 215 may decompose the user's email based on topics being discussed.

Those skilled in the art will appreciate that the same article may be decomposed in any number of ways. For example, a single article may be decomposed by author as discussed herein and metadata associated with the article related to the decomposition by author stored within the master profile 155 and/or author profile 160. The same article may also be decomposed multiple times by topic, context, subtext, perspective, depth, intent, and/or sentiment. Metadata may be generated that is associated with the decomposition and stored within the master profile 155, user profile 135, author profile 160, and/or author/user catalogs 165.

The content characterization engine 220 cooperates with the knowledge management engine 240 to use natural language processing, statistical analysis, and machine learning techniques to characterize the public content elements 105. In some embodiments, the content characterization engine 220 selects a content element 105, assigns one or more information classes to the content element 105 (possibly based on the search criteria from the infuser 205, the decomposition, and/or possibly from a review of the content thereon), and assigns content characterization scores to the content element 105 (or to each of the information classes of the content element 105). In some embodiments, the content characterization engine 220 scores inward-facing content characterization parameters (e.g., sentiment, intention, and depth). In some embodiments, sentiment refers to whether an author 120 or user 115 is for or against something. Intention refers to how an author 120 or user 115 is likely to react to a given circumstance, relative to a given AOI and/or AOE, etc. Intention may also refer to any intended messages the author 120 (or user 115) purposefully included in a produced article or other content element. Depth refers to the density of information (e.g., the density of facts) the author 120 or user 115 is interested in.

In some embodiments, the content characterization engine 220 scores outward-facing content characterization parameters (e.g., reach, reputation, resonance, recognition, region and range (referred to herein as the “6 Rs”)). The 6 Rs are defined as follows:
1) Reach—a normalized score that indicates the size or footprint of a content element 105;
2) Reputation—a normalized score that indicates the reputation and credibility of a content element 105;
3) Resonance—a normalized score that indicates how the intentions and sentiments of a content element 105 match those of other users 120 and/or authors 115;
4) Recognition—a normalized score that indicates the popularity of a content element 105 by reviewing how often that content element 105 has been referred to in other public content elements 105 or private content elements 170;
5) Region—information about the geographic region(s) relevant to a content element 105; and
6) Range—information about the geographic pattern of how a content element 105 has propagated.
   The content characterization engine 220 evaluates the 6 Rs of a content element 105 to determine a credibility score for the content element 105.

For each public content element 105, the content characterization engine 220 may also characterize the content source (e.g., website) to generate a content source score. In some embodiments, the content characterization engine 220 determines the content source score based on the credibility scores of the content elements 105 contained thereon. The infuser 205 may use the content source score to define the frequency at which the infused crawler 210 should crawl (e.g., re-crawl) the source to re-evaluate the content elements 105 thereon. The infused crawler 210 may use the content source score to define how deeply to crawl the website. The content characterization engine 220 may assign websites with greater credibility and/or reputation greater crawling status, so that they are crawled more frequently. Certain well-known sites may be given permanent high reliability and crawling status. Examples of these might include the United States Patent and Trademark Office and the New England Journal of Medicine.

To determine content characterization scores (e.g., sentiment, intention, depth and credibility scores) the content characterization engine 220 in some embodiments uses X-bar linguistic models and natural language processing. Bayesian statistical weightings may be applied to the content to reflect the weightings between key words of similar type. Several weightings may be applied to the key words. These weightings may arise from trends being tracked by the master profile 155. Language processing and a decision engine may also further characterize content from a content element 105 based on X-bar and natural language processing decomposition and characterization.

The content characterization engine 220 also characterizes the private content elements 170 of the user data 125. In some embodiments, the content characterization engine 220 selects a private content element 170, assigns one or more information classes to the private content element 170, and assigns content characterization scores to the private content element 170 (or to each of the information classes of the private content element 170). In some embodiments, the content characterization engine 220 scores inward-facing content characterization parameters, e.g., sentiment, intention and depth. In some embodiments, the content characterization engine 220 scores outward-facing content characterization parameters, e.g., the 6 Rs, to generate a credibility score. The parameters evaluated by the content characterization engine 220 for the public content elements and for the private content elements 170 need not be the same.

The author discovery and attribution engine 225 is hardware, software and/or firmware that cooperates with the knowledge management engine 240 to attribute an author 120 to each public content element 105 (and possibly a writer of each private content elements 170). As stated above, sometimes, the author 120 of a public content element 105 will be immediately identifiable. Other times, the author 120 will not. In some embodiments, when the author 120 is identifiable, the author discovery and attribution engine 225 will determine if the author 120 is also a user 115. If also a user, then the content characterization results from the content characterization engine 220 may be integrated into the user profile 135 of the author 120. If the author 120 is not a user 115, then the content characterization results may be integrated into the author profile 160 of the author 120. If the author 120 is not identifiable, then the author discovery and attribution engine 225 will create an unidentified-author identifier, and the content characterization results will be integrated into an unidentified-author profile 160 for the unidentified author 120. As described above, other possibilities exist.

It will be appreciated that, in some embodiments, the author discovery and attribution engine 225 may assist with the identification of writers in the user data 125, e.g., email when multiple persons are emailing each other.

In some embodiments, the author discovery and attribution engine 225 attempts to disambiguate author identities. For example, it is possible that the author discovery and attribution engine 225 may attribute content elements 105 of a single author 120 in the author catalog 165 to two different authors 120. During that time, the author discovery and attribution engine 225 may have been maintaining two different author profiles 160. The author discovery and attribution engine 225 may periodically scan the database of authors 120 looking for duplicates. If the author discovery and attribution engine 225 identifies two authors 120 that appear to be identical in almost all respects, then the author discovery and attribution engine 225 may merge the two author profiles 160 into one. In some circumstances, the authors 120 may be similar but not close enough for the author discovery and attribution engine 225 to merge them automatically, and may mark the potential duplicates for manual (human) analysis.

In some embodiments, the author discovery and attribution engine 225 may generate two author profiles 160 for a single author 120. For example, it is possible that a single author 120 completely switches sentiment and/or intentions as to a particular AOE and/or AOI. The author discovery and attribution engine 225 may generate a first author profile 160 for the author 120 as to that AOE and/or AOI during his first phase and a second author profile 160 for the author 120 as to that AOE and/or AOI during his second phase.

The author and user characterization engine 230 is hardware, software and/or firmware that cooperates with the knowledge management engine 240 to characterize a user 115 and/or author 120. In some embodiments, the author and user characterization engine 230 characterizes an author 120 by evaluating the information classes and content characterization scores of the content elements 105 attributed to the author 120. Similarly, the author and user characterization engine 230 characterizes a user 115 by evaluating the information classes and content characterization scores of the private content elements 170 of the user 115.

In some embodiments, the author and user characterization engine 230 determines the AOEs (and possibly AOIs) of the author 120 and determining the AOIs (and possibly AOEs) of the user 115. The author and user characterization engine 230 scores the sentiment, intentions, depth and credibility related to each AOEs (and possibly AOIs) of the author 120. The author and user characterization engine 230 scores the sentiment, intentions, depth and credibility related to each AOI (and possibly AOEs) of a user 115. Unless the user 115 has published any content elements 105, it is unlikely that the user 115 will have established any credibility, and therefore will not likely have any AOEs. In some embodiments, the author and user characterization engine 230 may not score the credibility of a user 115 (who is not also an author 120). The author and user characterization engine 230 stores the author scores and other information in the author's author profile 160. Similarly, the author and user characterization engine 230 stores the user scores and other information in the user's user profile 135.

One skilled in the art will recognize that the author and user characterization engine 230 may conduct a different characterization analysis based on whether an entity is a non-author user 115, is solely an author 120, or is an author/user 190. A non-author user 115 might include a user 115 who opted-in their private user data 125 but who has not authored or been identified as having authored any or a threshold number of public content elements 105. An entity who is solely an author 120 may be someone who has not opted-in their private user data 125 and who has been identified as having authored one or a threshold number of public content elements 105. An entity who is an author/user 190 may be someone who has opted-in their private user data 125 and who has been identified as having authored one or a threshold number of public content elements 105. An entity may switch labels as the circumstances change. Herein, the term “user” is intended to cover author/users 190 from the user perspective (being evaluated for receiving content elements 105 of predicted interest), and the term “author” is also intended to cover author/users 190 from the author perspective (being evaluated for matching with users 115).

In some embodiments, when characterizing a user 115 from user data 125, the author and user characterization engine 230 may consider the source of the user data 125 to determine a user's AOIs and AOEs. For example, the author and user characterization engine 230 may identify and characterize a user's AOEs by evaluating user data 125 from professional networks (e.g., LinkedIn). The author and user characterization engine 230 may identify and characterize a user's AOIs by evaluating user data 125 from less “noisy” social networks (e.g., Facebook, Google+, etc.). Further, the author and user characterization engine 230 may identify and characterize a user's casual interests by evaluating the user data 125 from “noisier” sites (e.g., Twitter, blogs, etc.). In some embodiments, the author and user characterization engine 230 may ignore and/or reduce the effects of the content from noisier sites (e.g., Twitter, blogs, etc.).

In some embodiments, when characterizing an author 120 from content elements 105, the author and user characterization engine 230 may consider the source of the content elements 105 to determine an author's AOEs and AOIs. For example, if an author 120 is published on more credible sites, then the author and user characterization engine 230 may increase the author's credibility score as to the relevant AOE (and possibly AOIs). If an author 120 is being published only on web-rags, then the author and user characterization engine 230 may reduce the author's credibility score as to the relevant AOEs (and possibly AOIs). Similarly, if an author 120 is constantly being mentioned in sites that are unknown to the author and user characterization engine 230 or known to lack any defined intention or context, the author and user characterization engine 230 may reduce the effects on the author's credibility score. Also, the author and user characterization engine 230 may modulate the degree to which noise impacts the credibility score by recognizing citations on credible sites.

In some embodiments, the author and user characterization engine 230 may incorporate a threshold analysis to determine whether an author 120 of a public content element 105 merits being identified as an author 120 in the system 100. For example, the author and user characterization engine 230 may not deem someone who has only written a few blog entries as an author 120. Similarly, the author and user characterization engine 230 may not deem someone who has written a single article that has reached high scores in the 6 Rs as an author 120. In some embodiments, the author and user characterization engine 230 may apply a hierarchy of characterizations on the above (or other) labels. For example, the author and user characterization engine 230 may deem someone who authored one or more but less than a threshold number of public content elements 105 as an “emerging author” and someone who has exceeded the threshold number of public content elements 105 and who has achieved a threshold credibility as a “full author.” Other sub-characterizations are also possible.

In some embodiments, the author and user characterization engine 230 may consider the dates of authorship for authors 120 of the public content elements 120 and for users 115 of the user data 125. Based on dates of authorship, the author and user characterization engine 230 can determine current interests and expertise and current sentiment, intentions, depth and credibility as to each AOI and/or AOE. Further, the author and user characterization engine 230 can track historical interests and expertise and current sentiment, intentions, depth and credibility as to each AOI and/or AOE.

The content propagation engine 235 is hardware, software and/or firmware that evaluates data propagation of content elements 105 from sources across public and private networks to end locations. The content propagation engine 235 observes how specific users propagate public content elements 105 (e.g., reply to it, re-tweet it, blog about it, post it to a social media site, or other propagation behavior). By observing propagation behavior, the content propagation engine 235 determines which network paths are most efficient. The content propagation engine 235 can track the propagation of public content elements 105 despite light modifications to the content element 105 after it is originally published (e.g., words added before or after it).

In some embodiments, the content propagation engine 235 can determine which users 115 have the largest influence on the 6 Rs of public content elements 105 after initial disclosure, who is causing the propagation, how each person impacted (e.g., amplified) the propagation of the public content element 105, and how a user 115 influenced user consumption. Impact may be measured by the number of propagation events (blogs, re-blogs, tweets, re-tweets, posts, re-posts, etc.), consumption by others, as well as the impact on intention and sentiment of those others, etc. The content propagation engine 235 can build pointers for the master profile 155 to record the paths of data propagation and the root cause of such paths. The content propagation engine 235 can track each public content element 105 across user histories to determine which specific events drove the 6 Rs of the public content elements 105 with specific groups or cohorts. The content propagation engine 235 can correlate the most relevant AOEs and AOIs associated with the propagation of the public content elements 105. The content propagation engine 235 can analyze the quality of public content elements 105 needed for propagation.

The user interface 245 is hardware, software and/or firmware that interfaces with a user 115, enabling the user 115 to provide access to his or her user data 135, to provide feedback on content elements 105 presented, to set content delivery preferences, and the like. The user interface 245 may include remote access software so that the user 115 can access the discovery system 130 remotely from his/her mobile device, laptop, desktop, etc.

The content selection engine 255 is hardware, software and/or firmware that cooperates with the knowledge management engine 240 to identify content elements 105 of predicted interest to a user 115. The content selection engine 255 may identify content items 105 of predicted interest automatically (e.g., via a dynamically generated query), in response to user request (e.g., via an express query), or via other request.

In response to an express search, the content selection engine 255 applies natural language processing, statistical analysis, and machine learning techniques to the search string itself before using it to extract relevant content elements 105. The content selection engine 255 reviews the searcher's user profile 135 to identify additional parameters about the searcher's AOIs related to the search request, and about the searcher's sentiment, intention and depth as to the AOI. The content selection engine 255 may also obtain additional information from the user's matrix about the user 115 (e.g., his/her current location, height, weight, academic degrees, cohorts, etc.), the user's behavior (e.g., the frequency with which they visit websites, etc.), the user's device (e.g., memory, processor speed, browser type, applications available, etc.), the network (e.g., the internet service provider), and/or external factors (e.g., the time of day, temperature, etc.). The content selection engine 255 generates confidence scores to arrive at a set of parameters to guide the search process. Based on the user request augmented by the search parameters, the content selection engine 255 in cooperation with the knowledge management engine 240 identifies information classes in the master profile 155. The information classes in the master profile 155 identify public content elements 105 related to the user's search. Alternatively and/or additionally, the content selection engine 255 may cooperate with a traditional search engine to identify content elements 105 relevant to the request.

In some embodiments, if the content selection engine 255 identifies a vast number of relevant content elements 105, the content selection engine 255 may evaluate the content elements 105 and/or metadata (e.g., sentiment, intention, depth and credibility) on the content elements 105 to generate a probability score defining the probable interest to the user 115. The content selection engine 255 may select a set of the relevant content elements 105 based on the probability scores (e.g., those exceeding a threshold probability, such as 95%) to identify those relevant content elements. 105 of sufficient probable interest to the user 115. In some embodiments, the content selection engine 255 may limit the pruning time, e.g., 2.5 seconds.

In some embodiments, if the content selection engine 255 still identifies a vast number of relevant content elements 105 of sufficient probable interest, the content selection engine 255 may compare the user profile 135 of the requesting user 115 against the author profiles 160 of the content elements 105 of sufficient probable interest to identify commonalities (including differences) between a user 115 and particular authors 120. The content selection engine 255 may generate likeness and/or unlikeness scores (generally referred to herein as “matching scores”) based on the commonalities. The content selection engine 255 may also compare user profiles 135 against each other to identify commonalities between users 115 to generate matching scores to identify like-minded and/or unlike-minded users 115. Further, the content selection engine 255 may compare author profiles 160 against each other to identify commonalities between authors 120 to generate matching scores to identify like-minded and/or unlike-minded authors 120. The content selection engine 255 uses the commonality results (e.g., matching scores) to assist with selecting a set of the relevant content elements 105 of sufficient probable interest to identify the content elements 105 of predicted interest to the user 115. Then, the content selection engine 255 may prioritize the content elements 105 of predicted interest to the user 115 based on the matching scores between the user 115 and each of the authors 120 of the public content elements 105 identified.

When there are too few content elements 105 linked to an information class, the content selection engine 255 will inform the infuser 205, which will initiate the infused crawler 210 to crawl the internet to identify relevant new content elements 105 to be added to the master profile 155.

To perform automatic selection (referred to sometimes as “auto-discovery” or “dynamic search”), the content selection engine 255 reviews the master profile 155 and/or user profile 135 to develop a search string similar to express search. The content selection engine 255 generates the search string as the result of a particular current interest identified from the user's user profile 135 or mass interest identified from the master profile 155. The content selection engine 255 then evaluates the automatically generated search string in the same way as discussed above regarding a string from an express search.

It will be appreciated that, as a user 115 is looking at discoveries 195 (e.g., content elements), the user 115 may wish to see discoveries 195 having the opposite sentiment or intention from what that user 115 normally wants. For example, the user 115 may wish to see discoveries 195 of authors 120 that oppose a particular scientific theory or political view that the user 115 espouses. In some embodiments, the content selection engine 255 allows the user 115 to invert his/her sentiment and/or intention around a particular AOI or AOE. The content selection engine 255 then identifies content elements 105 based on the modified AOI.

The content delivery engine 260 is hardware, software and/or firmware that delivers content elements 105 to a user 115. The content delivery engine 260 may control delivery of discoveries 195 through a variety of media, e.g., texts, emails, web pages, Facebook, Twitter, bulletin boards, portals, etc. The content delivery engine 260 can push the discoveries 195 to the user's device. The content delivery engine 260 may control delivery of discoveries 195 to a variety of different target devices, e.g., desktop computer, laptop, tablet, phone, e-reader, gaming device, tablet, etc. The content delivery engine 260 can be configured to notify a user 115 when discoveries 195 have been identified and/or delivered. The content delivery engine 260 may control the timing of delivery or notification of deliveries 195, e.g., daily, monthly, if the results exceed threshold confidence scores, upon request, etc. The content delivery engine 20 may allow a user 115 to set delivery preferences.

The content delivery engine 260 may allow a user 115 to share content with other users and/or groups of users. The user can ask the content delivery engine 260 to share discoveries 195 based on the particular content that the user 115 wishes to share, the content the user 115 has shared related to that AOI in the past, the audience with whom the user 115 has shared in the past, the pattern of interaction that the user 115 has had with other users 115, in private network or social networks or on the public Internet, or based on one or more variables stored in the user's user profile 135.

The dynamic curation engine 250 is hardware, software and/or firmware that evaluates user feedback (e.g., curation behavior that indicates the user's likes and dislikes of the content elements 105 presented) to dynamically adjust parameters associated with that user 115. Feedback may be derived from consumption behavior, propagation behavior; etc. For example, after a user 115 is presented with a discovery 195, the user 115 may indicate that the discovery 195 is not of interest. This could be done explicitly (by scoring or flagging it) or implicitly (by dismissing or not consuming it). The discovery system 130 may process the nature and speed of feedback to improve the quality and/or prioritization of future discoveries 195 for that and other similar users 115. In some embodiments, the dynamic curation engine evaluates the feedback to modify a user's AOIs/AOEs and sentiment, intentions and/or depth as related to the user's AOIs/AOEs, the credibility of the content element 105, the credibility of the author 120, and/or the like. The discovery system 130 updates the master profile 155, the user profiles 135 and/or the author profiles 160. Further, the dynamic curation engine 250 may modify the user profiles 135 of one or more other users 115, e.g., cohorts, like users, trend setters, trend followers, etc. and/or author profiles 160 of other authors 160 as they relate to the author 120.

In some embodiments, if a user 115 dismisses a discovery 195 after only seeing its title and the discovery system 130 had determined that the author(s) 120 or source(s) is/are one(s) that (a) the user 115 is known to like, (b) is credible in one of the user's AOIs or AOEs, or (c) is believed to be a good match with the user 115, then the dynamic curation engine 250 may interpret the user's reaction as a reflection on the title, and not on the author, content (which the user did not view) or topic. If the user dismisses a public content element 105 after viewing only a portion of the content, the dynamic curation engine 250 may analyze only that portion of the content viewed. Various interpretations can be made based on the consumption behavior of the user 115.

Similarly, in some embodiment, the dynamic curation engine 250 may evaluate the speed with which a user 115 dismisses a discovery 195. The speed may influence the level of negative weighting that the dismissal is given. Further, the dynamic curation engine 250 may weight the speed of dismissal based on the historical dismissal speeds from that user 115. When the dismissal speed is faster than typical, dynamic curation engine 250 may increase the negative weight of the feedback.

In some embodiments, the dynamic curation engine 250 may weight different portions of a discovery 195 differently. For example, the dynamic curation engine 250 may weight the early portion of an article lower because the early portion of an article often contains only introductory material. Similarly, the dynamic curation engine 250 may weight the later portion of the article lower because the later portion of the article often contains only summary information. The dynamic curation engine 250 may weight the middle portion of the article proportionally higher because the middle portion often contains the most detail.

The knowledge management engine 240 assists with building the master profile 155, the user profiles 135, the author profiles 160, the author/user catalogs 165, and other structures as needed. The knowledge management engine 24 also includes the engines for performing natural language processing, statistical analysis, and machine learning.

Using natural language processing, statistical analysis, and machine learning, the knowledge management engine 240 is capable of topic segmentation and recognition, sentiment analysis, word sense disambiguation, automatic summarization, discourse analysis, and the like. The knowledge management engine 240 can separate text into segments, each of which being devoted to a topic and identifying the topic of the segment. The knowledge management engine 240 can determine intended sentiment (including emotional state, general opinion) from text. The knowledge management engine 240 can determine attitude with respect to some topic or the overall contextual polarity of a document. The attitude may reflect judgment or evaluation, the affective state of the author at the time of the writing, or the intended emotional communication (i.e., the emotional effect the author wishes to have on the reader). The knowledge management engine 240 can determine the intended meaning of words having multiple meanings based on context. The knowledge management engine 240 can create summaries of text, e.g., using extraction and/or abstraction techniques. The knowledge management engine 240 can identify the nature of discourse relationships between sentences (e.g. elaboration, explanation, contrast). The knowledge management engine 240 can recognize and classify speech acts in text (e.g. yes-no question, content question, statement, assertion, etc.). The knowledge management engine 240 can determine the depth, i.e., the level of details or complexity, of text. The knowledge management engine 240 can also evaluate text to determine the author's intentions, i.e., what the author intends to do or not to do, wishes to do or not to do, etc. By learning the topics of interest to an entity (e.g., a user 115 or an author 120), the entity's sentiment, intentions and/or depth as to each topic, and the reaction of other users 115, the knowledge management engine 240 in cooperation with the components herein can determine the entity's AOIs and AOEs.

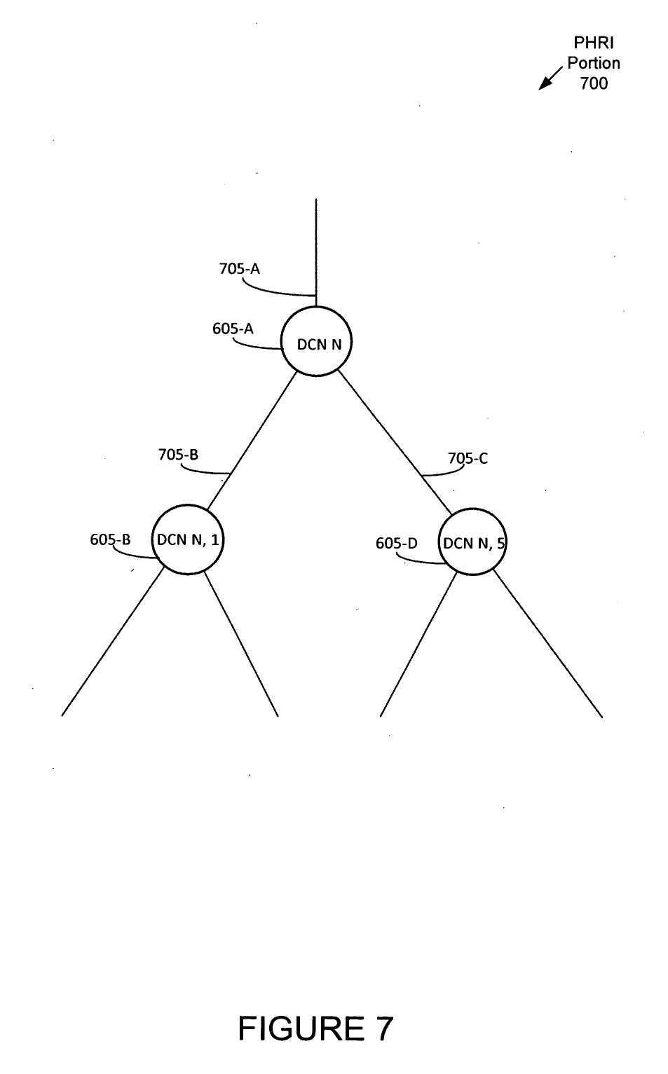

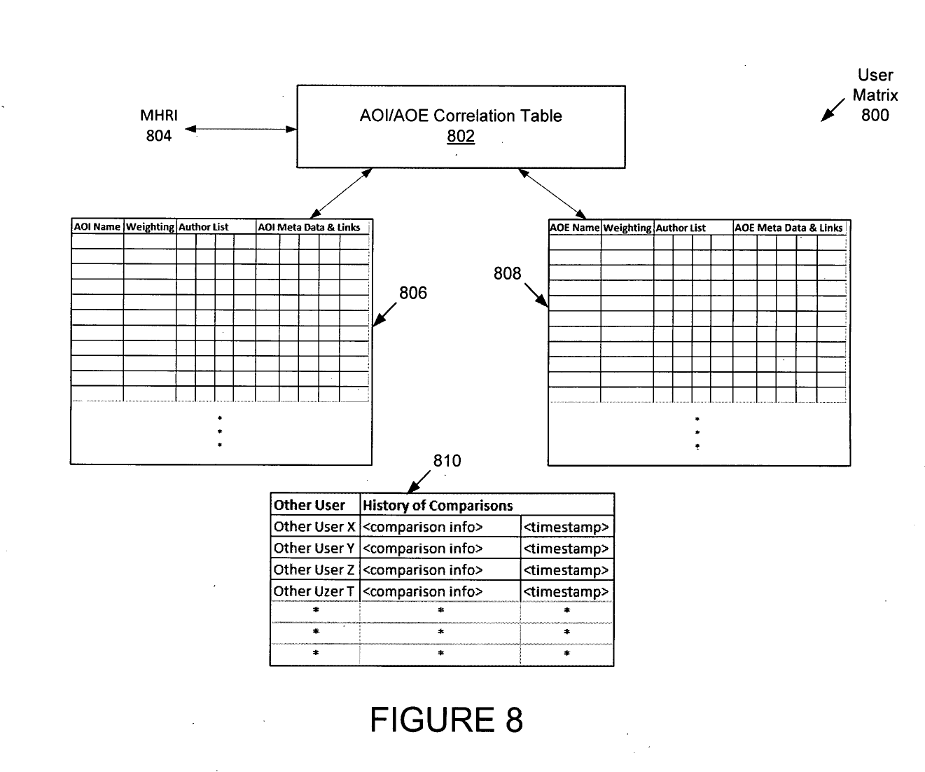

As stated above, a user profile 135 includes a personal hierarchical reasoning index (or PHRI) 140 and a user matrix 150 for each user 115. The knowledge management engine 240 stores the information it gleans from the user's user data 125 in the PHRI 140 and the user's user matrix 150. In some embodiments, the PHRI 140 is a subset of the MHRI 175 and represents a user's AOIs and AOEs as well as the user's sentiment, intentions, depth and credibility as to each AOI and/or AOE. Additional details of a PHRI 140 are provided with reference to FIG. 7. Additional details of a user matrix 150 are provided with reference to FIG. 8.

As stated above, an author profile 160 includes a PHRI 180, an author matrix 185 for each author 120, and author/user catalogs 165. The knowledge management engine 240 stores the information it gleans from the author's public content elements 105 in the PHRI 140 and the author's author matrix 150. In some embodiment, the PHRI 180 may be similar to a PHRI 140, and an author matrix 185 may be similar to a user matrix 150, except that each of a PHRI 180 and an author matrix 185 may be based only on public content elements 105.

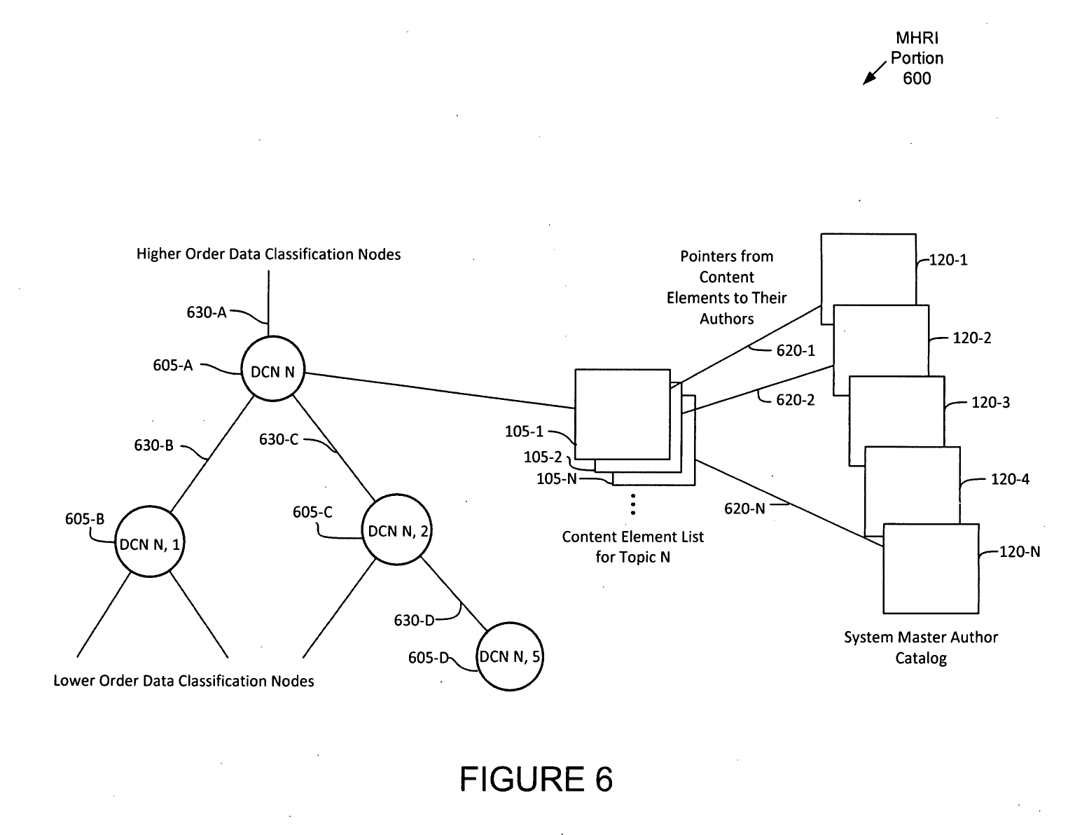

As stated above, the master profile 155 may include or be a master hierarchical reasoning index (or MHRI) 175. The MHRI 175 is a large index that connects content elements 105, websites, users 115, authors 120 and other system elements together. Additional details of the MHRI 175 are provided with reference to FIG. 6.

The knowledge management engine 240 uses the information is determines and stores to conduct regular background studies to note trends, make predictions, etc.

For example, the knowledge management engine 240 can maintain a global list of AOIs and AOEs that it has created from data mining, clustering and other machine learning techniques. The knowledge management engine 240 may maintain thousands of AOIs and AOEs and may create new ones over time. For each user, the knowledge management engine 240 uses the user data 125 of a user 115 to identify and prioritize the current interests and AOIs of a user 115.

Similarly, the knowledge management engine 240 may identify and prioritize authors 120 that are most relevant for that user 115 in each AOI. The knowledge management engine 240 may rank authors 120 based on the matching scores discussed above. For each AOI of a user 115, the knowledge management engine 240 may maintain links to other metadata relevant to the AOIs including links to browsing history, demographics, user metadata history, NLP weightings, etc.

The knowledge management system 240 maintains the commonalities between a user 115 and authors 120 in the user matrix 150 associated with the user 115. In addition to the differences found, the knowledge management system 240 will also store a timestamp associated with the operation. This allows the knowledge management system 240 to look at the evolution of user matrix 150 as it compares to other user matrices 150. The knowledge management system 240 may also employ a technique called “Triangle Modeling” to determine the various “edges” of each user's connections to others. The connection among three users A, B, and C is stronger if user A is connected to users B and C. In addition, because users B and C have connections to user A, users B and C may also be considered by the knowledge management system 240 to have a connection to each other.

The knowledge management system 240 monitors time evolution of data. For example, the knowledge management system 240 may make a copy of every user's and author's matrices 150 periodically. The knowledge management system 240 evaluates for variances over time to improve results.

The knowledge management system 240 may associate like users 115 into groups and consider the trajectory of their respective user matrices 150 to aid in predicting AOIs. For example, the knowledge management system 240 may evaluate user profiles 135 of other users 135 who have followed a similar trajectory to predict how a user's preferences might trend in the future. For example, if many users have trended from state A to state B to state C, and a particular user 115 has transitioned from state A to state B, the knowledge management system 240 may weight content elements 105 trending towards state C for the particular user 115.

The knowledge management system 240 may compare pairs of user matrices 150. The knowledge management system 240 attempt to determine divergences in sentiment, intention and depth as they relate to specific AOIs/AOEs. The knowledge management system 240 uses the differences to reexamine content previously determined as not relevant. If the knowledge management system 240 determines that there are content elements 105 that are relevant to the differences between the two users 115, then the knowledge management system 240 admits the content elements 105. The knowledge management system 240 modifies the user matrices 150 for the two users 115. The knowledge management system 240 modifies the master profile 155 and user profiles 135 as appropriate.

The knowledge management system 240 may evaluate trending in a gradually increasing interval. For example, the knowledge management system 240 may evaluate the trending according to the following intervals:

1) One week

2) One month

3) 4 Months

4) 9 months

5) 16 months

6) 20 months

The optimum intervals depend on the specific of the data being examined.

The knowledge management system 240 may employ the user of weighting factors to adjust certain inputs in certain months, e.g., that coincide with vacations, that vary by geography, that vary by weather patterns, etc. For example, in the northern hemisphere, the knowledge management system 240 may lower weightings of certain inputs in August.

The knowledge management system 240 may differentiate the author characterization parameters based on author type. For example, a brand a brand cannot have intention, sentiment, sarcasm, etc.

The knowledge management system 240 may cluster users 115, authors 120, content elements 105, sources of content elements 105, and all other information. The knowledge management system 240 may use a combination of supervised and unsupervised data mining, possibly arranged in a cascading fashion. At each stage where classes of data items are divided into subclasses, the knowledge management system 240 may collect score vectors to determine the root cause of separation and may create higher level clusters grouped by commonalities and specific data points that fall outside the interest points of the users being divided into a new group.

The knowledge management system 240 may also use behavioral clustering to determine if certain groups of metadata have too much of an overlap in certain demographics. As a result of this, the knowledge management system 240 may couple the categories, despite a previous decision to keep them separate.

In various embodiments, the content decomposition engine 215 and/or the content characterization engine 220 are a part of the knowledge management engine 240. In one example, the content decomposition engine 215 and/or the content characterization engine 220 are a part of the knowledge management engine 240 to allow for improved performance and/or high I/O availability.

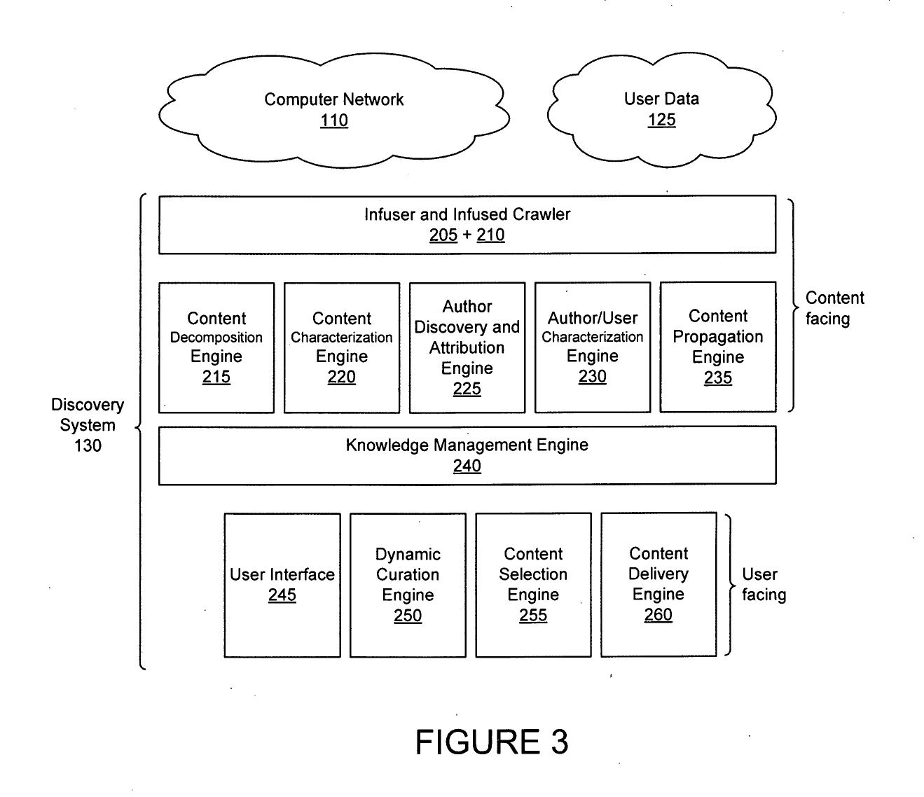

FIG. 3 is a diagram illustrating additional or alternative details of the discovery system 130 in some embodiments. The details are similar or identical to the details described with reference to the embodiments of FIGS. 2a and 2b. Accordingly, like numbers are being used. As shown, the discovery system 130 includes content-facing components including the infuser and infused crawler 205 and 210, the content decomposition engine 215, the content characterization engine 220, the author discovery and attribution engine 225, the author and user characterization engine 230, and the content propagation engine 235. The discovery engine 130 also includes user-facing components including the user interface 245, the dynamic curation engine 250, the content selection engine 255 and the content delivery engine 260. Cooperating with some or all of the content-facing and the user-facing components is the knowledge management engine 240. The infused crawler 210 accesses the computer network 110 and the user data 125 to gather the necessary data to perform its function.

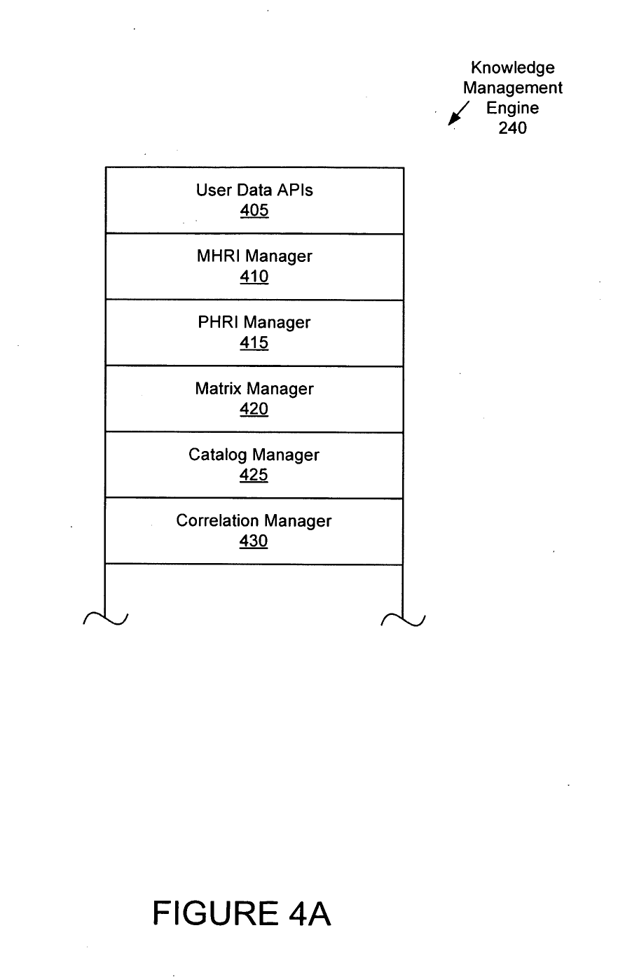

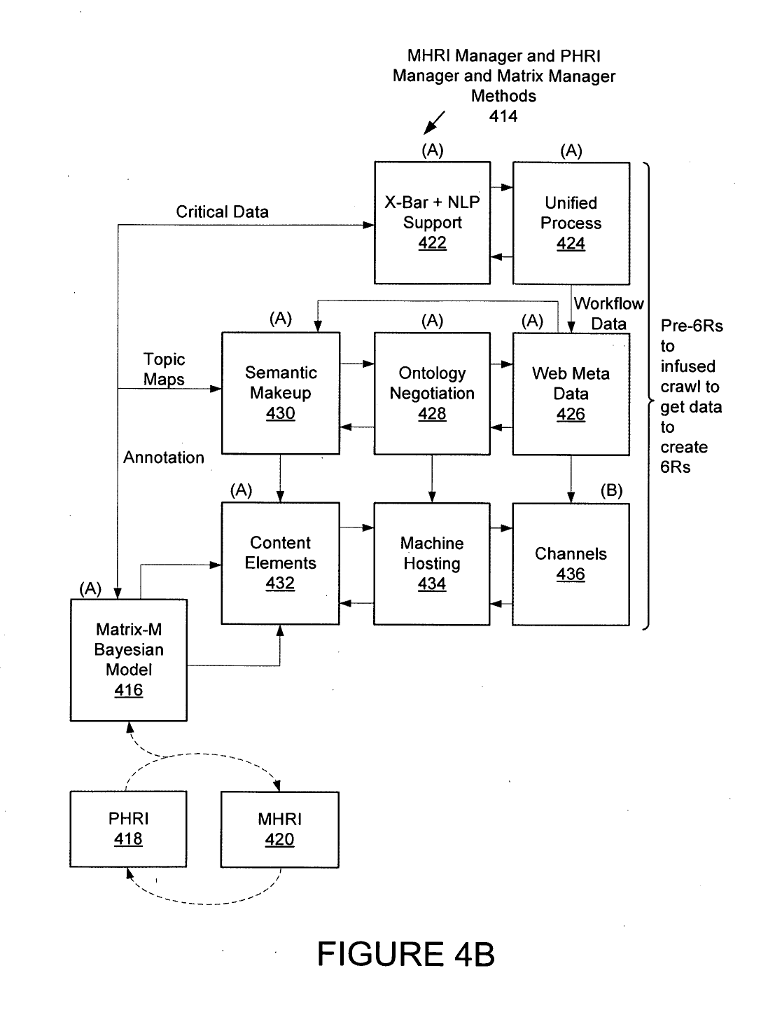

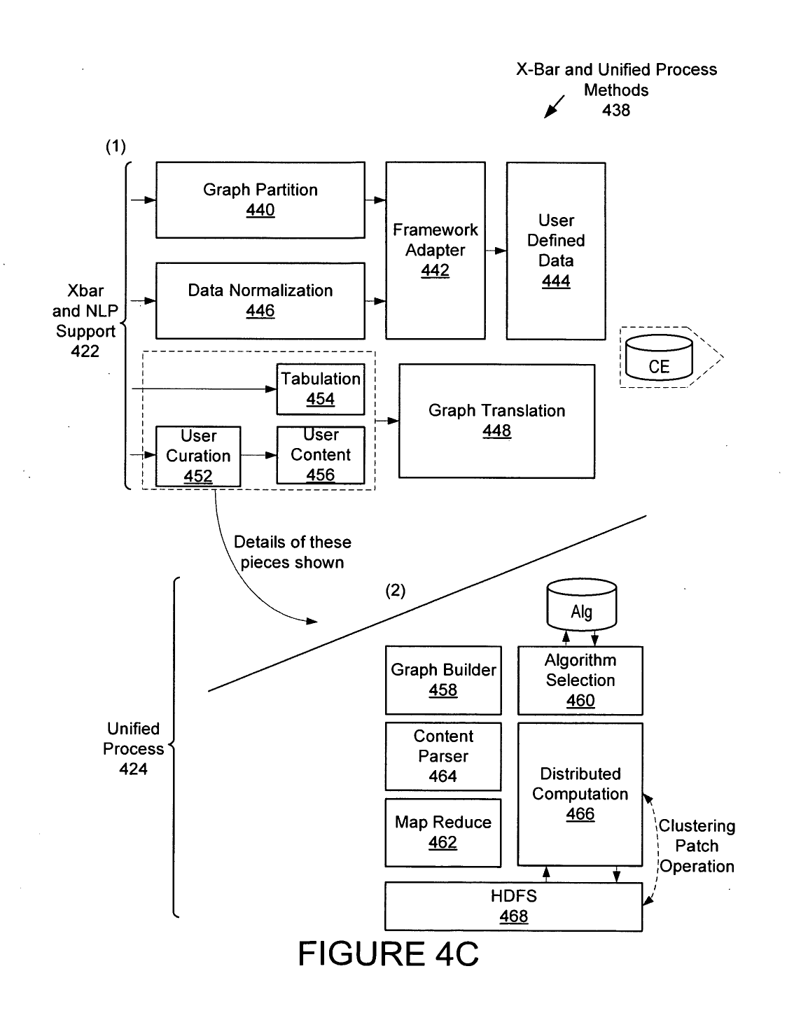

FIG. 4a is a diagram illustrating details of the knowledge management engine in some embodiments. The knowledge management engine 240 includes user data APIs 405, MHRI manager 410, PHRI manager 415, matrix manager 420, catalog manager 425 and correlation manager 430.

The user data APIs 405 is hardware, software and/or firmware that includes the application programming interfaces for accessing the user data 125 opted in by the user 115. For example, the users data APIs may include a LinkedIn API, a Facebook API, a Google+ API, a Twitter API, etc.

The MHRI manager 410 is hardware, software and/or firmware that interfaces with and maintains the MHRI 175.

The PHRI manager 415 is the hardware, software and/or firmware that interfaces with and maintains the user PHRIs 140 and author PHRIs 180.

The matrix manager 420 is the hardware, software and/or firmware that interfaces with and maintains the user matrices 150 and author matrices 185. In some embodiments, the matrix manager 420 comprises a matrix load balancer which handles inputs to the matrix manager 420. The matrix load balancer may allow for scalability and interaction with 3^{rd} party APIs.

The catalog manager 425 is the hardware, software and/or firmware that interfaces with and maintains the author/user catalogs 165.

The correlation manager 430 is the hardware, software and/or firmware that performs natural language processing, statistical analysis, and machine learning as described herein to assist all the other relevant components to perform their functions (e.g., infusion, crawling, content decomposition, content characterization, author discovery and attribution, author and user characterization, content propagation, dynamic curation, content selection and content delivery).

FIG. 4b is a diagram 414 illustrating details of the knowledge management engine 414 in some embodiments. In various embodiments, the knowledge management engine 414 determines and/or characterizes at least one of the 6Rs associated with content elements produced by one or more users and/or authors. In some embodiments, cross-referencing information associated with the MHRI and/or with information retrieved by the infused crawler may be utilized to build the 6Rs.

In various embodiments, the knowledge management engine 414 utilizes processes as discussed with regard to diagram 414 to determine what has to be crawled in the communication network in order to determine one or more of the 6Rs of a user's or author's produced content elements. Those skilled in the art will appreciate that the PHRI manager and the MHRI manager will feed into the matrix manager by characterizing retrieved content elements. The knowledge management engine 414 may comprise a matrix M Bayesian model 416, a PHRI 418, an MHRI 420, an X-Bar and NLP Support 422, a unified process 424, a web meta data 426, an ontology negotiation 428, a semantic make up 430, context elements 432, machine hosting 434, and channels 436.

In some embodiments, one or more content elements are retrieved from the MHRI 420. Selection of the content elements may be, for example, based on the user profile (e.g., PHRI 418) to identify content elements produced by a user(s) and/or author(s) associated with an AOI or an AOE. Selecting content elements for assessment may be based on prioritization of the AOIs or AOEs. For example, a user may have ten AOI and AOEs. The matrix M Bayesian model 416 or controller may order the AOIs and AOEs based on the most recent personal information consumed or produced by the user(s) and/or author(s). The matrix M Bayesian model 416 or controller may select content element(s) associated with the top AOIs and AOEs (e.g., associated with a top predetermined number of AOIs and AOEs such as the top three of both).

Those skilled in the art will appreciate that, in some embodiments, at least some history of personal information (e.g., other content elements produced or consumed) may provide context for the previously selected content element. Further, the history of the personal information (e.g., data consumed by the user and/or produced by the user for a period of time such as the most recent period of time) may provide depth, intent, sentiment, and/or any other information which may be used to further characterize retrieved data and/or generate the probability score associated with the retrieved data (e.g., the probability that the retrieved data is content of predicted interest for the user).

Utilizing tracked time associated with personal information (e.g., when the information was consumed or produced), the matrix M Bayesian model 416 provides the selected content elements and associated metadata over time (i.e., the critical data) to the X-Bar and NLP support 422, the semantic make up 430 and/or the content elements 432.

In some embodiments, a Bayesian model is utilized because associating the previously selected content elements with past information produces a state (e.g., this portion of the system may not be stateless). Those skilled in the art will appreciate that even though the matrix M Bayesian model 416 identifies the Bayesian model, many models may be used including a model that is not Bayesian.

In various embodiments, the X-Bar and NLP support 422 retrieve semantic information and intent from critical data provided by the matrix M Bayesian model 416. In some embodiments, the X-Bar and NLP support 422 utilize natural language processing to identify semantic information associated with the critical data. In one example, the X-Bar and NLP support 422 utilizes open NLP to identify the semantic information. The X-Bar and NLP support 422 may also utilize X-Bar theory to determine intent potentially based in part on the semantic information. Those skilled in the art will appreciate that even though the matrix X-Bar and NLP 422 identifies the X-Bar theory, many models may be used including other techniques that do not include X-Bar theory.

In some embodiments, the X-Bar and NLP support 422 determines if there is a positive message, negative message, personal message, and/or general message in the critical content data. A personal message may suggest that the critical content data may be associated with personalized information such as Facebook updates while a general message may suggest that the critical content data may be associated with public statements such as Tweets over Twitter.

The X-Bar and NLP support 422 may determine, for example, the language utilized by one or more users to communicate information.

In various embodiments, the knowledge management system applies an information theory graph based on information concentration algorithms. When a user generally writes to a personal friend, the system discussed herein may determine a type of information conveyed as well as the density of the information conveyed. The knowledge management system may also determine if one-on-one discussions are characterized as having a higher or lower density of information. Similarly, when a user generally writes to a general audience, the system discussed herein may determine a type of information conveyed as well as the density of the information conveyed.

In various embodiments, sentiment and intent from the X-Bar and NLP support 422 are correlated and may be used with the information theory graph(s). The information theory graph(s) may indicate how one or more users communicate and/or are deriving information.

Utilizing information from the X-Bar and NLP support 422 (e.g., sentiment, intent, and/or information from information theory graph(s)), the unified process 424 may identify clusters of information associated with others in the MHRI 420 and how the critical data maps to each other. For example, one cluster may include personal information (e.g., Facebook posts) that has positive sentiment and another may be general information (e.g., Tweets) that have a negative sentiment. Any number of clusters may be generated (e.g., ten) for different combinations of data determined by the X-Bar and NLP support 422.

In various embodiments, the unified process 424 may score accuracy of clustering and accept one or more clusters if the accuracy is greater than an accuracy threshold.

In some embodiments, the web meta data provider 426 may receive information from the MHRI 420 including both the critical information as well as information within the clusters. The web meta data provider 426 may pull information including, for example, where information associated with the critical information and/or information associated with the clusters is indexed, what is the time stamp of any or some of such information, who were associated authors (e.g., who wrote similar types of information), or the like. Those skilled in the art will appreciate that the web meta data provider 426 may retrieve information to determine where the clustered information and/or the information from the X-Bar NLP Support 422 may be found in the communication network and how to find it in comparison to the sequence of timing.

Ontology negotiation 428 compares patterns within the MHRI associated with the data with user profiles (as described by the web meta data 426) (e.g., the ontology negotiation 428 may compare patterns within the MHRI 420 to the overlay of the PHRI 418). The ontology negotiation 428 may find relevant additional relevant points to nodes and builds deltas (differences). For example, the ontology negotiation 428 maps the overlay of the PHRI 418 over the MHRI 420 which may identify the closest association of the interest of the user and one or more nodes of the MHRI 420. The ontology negotiation 428 may identify data elements between the interest of the user and the nodes of the MHRI 420 (e.g., via clustering of nodes about one or more points associated with the PHRI 418 overlay). The ontology negotiation 428 may determine the probabilities (e.g., probability of likely interest) and specification scores for these hops to generate a blended score.

In one example, the ontology negotiation 428 may determine a 5% delta between a user's knowledge (based on the critical data) and the factual information of the MHRI 420. In some embodiments, the information contained within the MHRI 420 is credible or is associated with credibility scores and so the nodes in the MHRI 420 may be associated with credible content elements. Since the ontology negotiation 428 has determined that there is a 5% delta between the knowledge of the user based on the critical data and the MHRI 420 in this example, the ontology negotiation 428 may determine a 95% of probability and specificity score that the user's knowledge on that particular node. As such, if this is an AOE, then the user fits in the 95^{th} percentile. It shows where the user may fall in an expertise. Expertise ranges may range from 96%-99% or any range depending on the topic. As such, the user's knowledge associated with the critical data may assist in identifying the user's expertise.

In various embodiments, the web meta data 426 may bypass the ontology negotiation 428 and feed data directly to the semantic makeup 430. For example, the web meta data 426 may bypass the ontology negotiation 428 and feed data directly to the semantic makeup 430 when there is less than a threshold (e.g., less than 16 KB) of supporting metadata since the ontology negotiation 428 may be limited in its ability to change the data structure (e.g., the ontology negotiation 428 may be unable to change the data structure more than 1.5-2.0%).

The semantic makeup 430 may compare the author's data with the user's data to identify the difference in communication (e.g., sentiment, depth, and/or the like).

The content elements 432 may be utilized by the infused crawler when crawling the communication network to identify content elements of the same topics that also may share characterizations or vectors based on information from the semantic makeup 430. As such, copies of content elements and content elements from the user found on the communication network may be identified or associated.

In some embodiments, content elements 432 may validate data in the web meta data 426 based on historic data available in the MHRI 420. In one example, this may be viewed as a pseudo-cache method to speed process and off-load work from the semantic makeup 430.

In one example of the system as described with regard to the depiction of FIG. 4b, a user produces content elements associated with California wines, which is associated with one of the user's AOEs. In this example, the knowledge management engine may determine one of the six Rs such as Reach (e.g., the number of hops the produced content element or message of the produced content element propagate in the communication network and does this replicate what and expert message look like.) In the MHRI 420, there is a recognized expert in the wine industry who has written on similar topics as the user's produced content element; on average, the recognized expert may have a reach of seven for similar articles produced by the recognized expert.

In this example, articles in Facebook and Twitter by the user associate a wine varietal and vintage with food pairing and price. Data elements such as price, pairing, and vintage may be within the produced content. The content element may include, for example, a general message on Twitter with these data elements. The content elements also include Facebook updates with more specific information regarding these data elements.

The X-Bar and NLP Support 422 may determine that the personal messages are very exact and dense compared to the general messages which are not very dense. General messages also tend to be more positive.

The information from the web meta data 426 may indicate the time frame (e.g., over the last month), the number of characters for each content element (which may indicate density and context), and/or the message. The ontology negotiation 428 may look to the MHRI 420 over the last month for authors who have written similar information (e.g., information with similar data elements such as price, pairing, and vintage). The user's message may be mapped to three nodes (e.g., three content elements associated with different authors). One author may disagree with the user regarding price (e.g., user says fair price and the author says high price). The delta between the user's message and the author's content element is determined to identify other nodes between the user's message and the author's content elements.

Delta may be, for example, 6%. Two other authors within or close to the delta may also indicate that the price range is fair but only compared to more expensive wines. If the user only made general statements (e.g., on Twitter) about the price fairness of the wine and did not provide specific comparisons that can be further assessed, the knowledge management system may determine (based on the comparison with content elements in the MHRI 420 from previously identified experts) that the user is not an expert in this particular data point unless there is more information from the user.

The same process may be utilized with the delta points to determine expertise as well as reach as compared to other experts. Expertise may further be scored and characterized. For example, based on the system as described herein, the knowledge management system may determine that the user is a common expert for general authors or an expert for other experts. The knowledge management system may build any number of dimensions for one, more, or any of the 6Rs.

Those skilled in the art will appreciate that similar systems may be used to characterize interests as well as expertise. For example, a user's interest may be compared to other users who produce similar content and their interest. As a result, a user's interest may be scored (e.g., grouped with those of a similar level).

Machine hosting 434 is configured to control efficient receiving, sending, and/or processing of information. In various embodiments, the machine hosting 434 controls parallel processing and/or multithreading to improve efficiency (e.g., for optimization). The machine hosting module 434 may, for example, perform patch processing as needed to improve efficiency. Those skilled in the art will appreciate that machine hosting 434 add or change parallel processing and/or multithreading depending on load conditions. The machine hosting 434 may also take advantage of cloud computing and/or virtual machines to improve processing and/or throughput.

The channels 436 may comprise logical connections for dispersed information going from and coming to the discovery system. For example, the channels may indicate a number of dispersed sets of personal information coming to the discovery system for one or more users. The channels may be the number of threads that can be run. If the number of channels utilized exceeds a channel threshold, the machine hosting 434 may perform parallel computation as opposed to one string.

FIG. 4c is a diagram 438 illustrating details of the knowledge management engine in some embodiments. The diagram 438 comprises logical elements of the X-Bar and NLP support 422 and the unified process 424.

X-Bar and NLP support 422 may comprise the graph partition 440, frame work adaptor 442, user defined data 444, data normalization 446, graph translation 448, user curation 452, tabulation 454, and user content 456. The graph partition 440 may receive critical data which may appear as a flat file of all or some unstructured data. In order to apply natural language processing, the graph partition 440 may generate a structure for the critical data. In some embodiments, the graph partition 440 groups information for processing to allow for processing (e.g., for parallel processing). In one example, the X-Bar and NLP support 422 utilize the graph partition 440, the frame work adaptor 442 and the user defined data 444 to create batches for processing.

The frame work adaptor 442 may generate edge graphs between (e.g., associated with) any number of content elements in different partitions. In one example, the frame work adaptor 442 determines where the edges of the information theory graph. In some embodiments, the frame work adaptor 442 finds the associations so that we can break up data in clustered fashion for processing.

In some embodiments, the user defined data 444 determines what the associations of the edges are. In one example, there may be a continuous conversation regarding wine over time. Even though the conversation may be represented by several content elements over time, the frame work adaptor 422 may not break the context of a conversation (e.g., the frame work adaptor 422 may not generate an edge graph between content elements associated with the same continuous conversation). As a result, information may be contained within an edge node to find how the information of the edge node relates to other information (e.g., other edge nodes). Those skilled in the art will appreciate that the graph partition 440, the frame work adaptor 442 and the user defined data 444 may create batches where an entire conversation may be placed in a particular batch. In some embodiments, the batches may not be put into a particular context until the next stage.

Data normalization 446 may utilize the x-bar theorem and semantic extraction on the batches from the user defined data 444 as discussed herein.

Those skilled in the art will appreciate that the same conversation may be processed in many ways. In some embodiments, where there are multiple topics within a single conversation, a separate batch may be created for one, more, or all topics. For example, each batch may preserve the contextual flow of information over time. In another example, the intent of the conversation with regards to a particular topic may be preserved over time.

In another example, a conversation regarding a single topic between two people over time may be preserved in a node (e.g., a first batch). If a third person joins the conversation regarding the single topic, another node (e.g., a second batch) may be created. The two nodes or batches may be connected by an edge representing the topic of conversation.

Those skilled in the art will appreciate that the graph partition 440 may select the graphs, the frame work adaptor 442 may determine the nodes to recognize, and the user defined data 444 may determine how to link data. In various embodiments, the graph translation 448 may construct the graph in an organized (e.g., hierarchical) fashion.

The user Curation 452 and/or the tabulation 454 may comprise one or more parsers. In various embodiments, one or more parsers parse critical data of the batches to attempt to match all or parts of critical data batches with content elements (e.g., user content 456) and/or user curation 452. In various embodiments, the parser(s) selects algorithms to process one or more batches. The tabulation 454 may organize subsets of parsed information into organized data structures (e.g., tables) which may be utilized by the graph translation 448. The graph translation 448, in some embodiments, may assist in determining how batches are built. One or more of the parsers may assist in generation of time sensitive hashes based on streaming data from the data normalization 446.

Those skilled in the art will appreciate that one, some, or all of the components of the X-Bar NLP support 422 may operate independently and/or simultaneously.

The unified process 424 comprises the graph builder 458, algorithm selection 460, content parser 424, map reduce 462, distributed computation 466, and HDFS 468. The graph builder 458 may determine and/or utilize deltas between associations (e.g., between critical data and that of information of another interested party in the MHRI 420). The algorithm selector 460 may select and/or utilize different algorithms for different natural language processing. In one example, the algorithm selector 460 may select algorithms depending on density of information or amount of semantic information. The algorithm selector 460 may base algorithm selection on information received from the graph translation 448. Once algorithms are selected for each batch

In some embodiments, batches with similar algorithms may be clustered together. Context parser 464 and map reduce 462 are intertwined and may identify content requirements through the selected algorithm from the algorithm selection 460. In some embodiments, map reduce 462 removes deltas and algorithms find context to build user content 456 and user curation 452 feedback.

In some embodiments, if there is new content, or comparing to others, this process may break up content.

The distributed computation 466 may process the batches from the map reduce 462 and content parser 464 which may ultimately be provided to a file system such as HDFS 468 (Hadoop Distributed File System). Although HDFS 468 identifies the file system as a Hadoop Distributed File System), many file systems may be used.

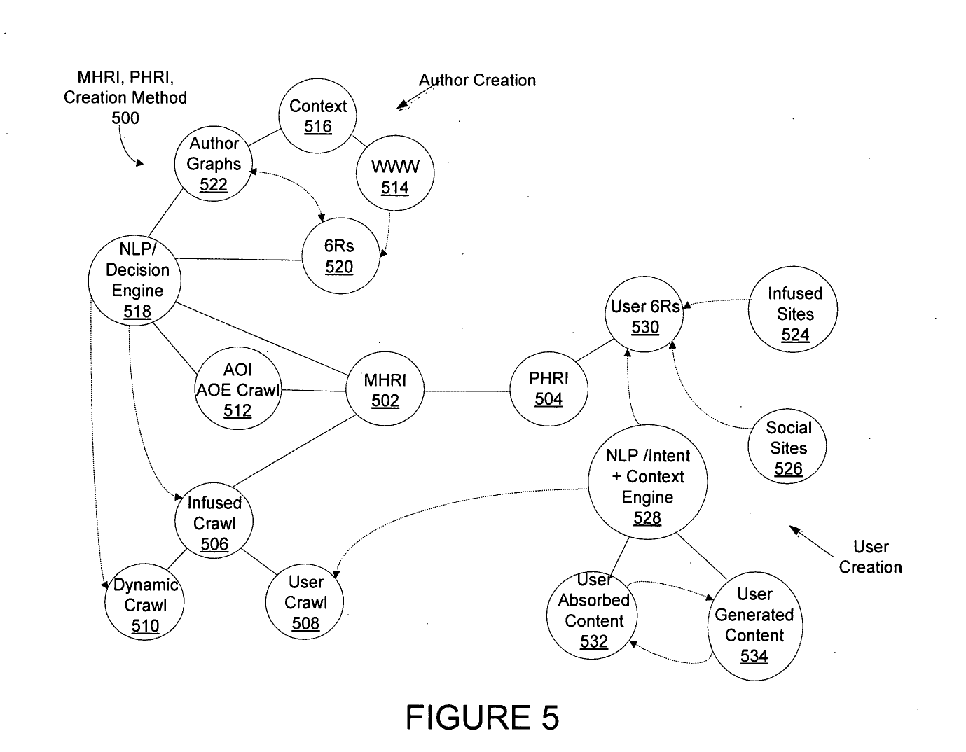

FIG. 5 is a diagram 500 illustrating a method of creating the MHRI and PHRIs in some embodiments. Diagram 500 depicts an MHRI 502, a PHRI 504, an infused crawler 506, a user crawl 508, a dynamic crawl 510, a AOI/AOE crawl 512, a communication network 514, a content element 516, a natural language processing/decision engine (NLP/DE) 518, a 6 Rs module 520, author graphs 522, infused sites 524, social sites 526, NLP/Intent and context engine 528, users 6 Rs module 530, user generated content 532, and user absorbed content 534.

The MHRI 502 comprises one or more master data structures configured to store available data in an organized format. In some embodiments, the MHRI 502 organizes data in a hierarchical format. In one example, the MHRI 502 comprises nodes structured in a hierarchical format. The hierarchical format may be based, for example, on topics, classifications, or any other kind of information.

Each node of the MHRI 502 may include data and/or pointers to data located elsewhere. For example, a pointer may point to data in one or more other databases, one or more other files, and/or on one or more network (e.g., on the communication network 514).

In some embodiments, each node of the MHRI 502 comprises an array which identifies an independent class and defines relationships with other nodes and/or topics. Each array may comprise any number of entries and may be any dimension. Information associated with each node may include factual relationships as well as metadata regarding density of information, sentiment, intent, authorship, credibility score, scores for one of more of the 6Rs, and/or any other kind of information. As a result, in some embodiments, the MHRI 502 is not a simple tree structure but tracks interrelationships between data and metadata in an organized format.

The PHRI 504 comprises one or more data structures associated with one or more users. In one example, each of a plurality of PHRIs 504 is associated with a different user. In some embodiments, each PHRI 504 comprises nodes with pointers to nodes within the MHRI 502. Nodes within an individual PHRI 504 may be generated and/or associated with nodes within the MHRI 502 based on data associated with the user or group of users. In one example, the PHRI 504 comprises nodes with pointers that point to a subset of nodes in the MHRI 502.

In various embodiments, each PHRI 504 contains nodes that point to data of interest for a user. In one example, nodes within a PHRI 504 may point to different nodes at different positions within the MHRI 502. The nodes within the MHRI 502 may contain and/or point to data of interest associated with one or more users of one or more PHRIs 504. Metadata associated with the nodes of each PHRI 504 may be stored by the user profiles discussed herein.

For example, a user's PHRI 504 may reflect a user's interests in BMW automobiles which may be comparatively constrained when compared to the amount of information associated with BMW automobiles contained within the Internet and/or associated with the MHRI 502. While the information associated with the Internet and/or the MHRI 502 may include general as well as specific information, the PHRI 504 may reflect the PHRI 504 user's interests.

In some embodiments, nodes within a PHRI 504 may point to different nodes within the MHRI 502 that may reflect the user's interests which, as a result, the PHRI 504 and/or metadata associated with the PHRI 504 may allow for the capture of a context of the user's interests. For example, different users may be interested in different aspects of barbecue grills. The first user may be interested in personally building a barbecue grill, performance of personally built grills, the materials needed to build a grill, the location of materials needed to build a grill, past problems identified by others, as well as stories of building success. The second users may be interested in purchasing a grill, grill reviews, comparisons of different grills, availability of the grills, availability of specialty fuels for commercial grills and the like. Although both are interested in grills, information of interest between the two users may be different. Metadata associated with the context of content associated with grilling, both consumed and produced, by the different users may be stored in the PHRI 504 and/or user profiles associated with the PHRI 504.

Nodes contained within the PHRI 504 and/or the user profile may indicate how the user of the PHRI 504 reaches decisions. For example, the PHRI 504 and/or user profile may structure or relate to structure of pointers of the nodes of the PHRI 504 in such a way as to reflect a decision-making process whereby information may be retrieved that reflects not only the user's interests but may assist the user by reflecting the user's thought process. As a result, retrieved information may not only be relevant to the user's interest, but may also be relevant to the user's interests in obtaining the information.

In one example, if a user is interested in a purchase of a particular make of car, the 504 and/or the user profile for that user may indicate that horsepower is the biggest concern, followed by room in the car, and, last, price. In some embodiments, the PHRI 504 and/or the user profile comprises pointers to data or data that indicate all or part of a decision-making process for the user and, as such, nodes within each user's individual PHRI 504 and/or the user profile may be directed to different information.

The infused crawler 506 may retrieve relevant information of interest to a user from the communication network 514. In various embodiments, an infuser (discussed herein) may be configured to generate an information request for relevant information for one or more users. The infuser may base the request or include within the request any amount of information. The infuser may base the request on a search request submitted by the user (e.g., a user crawl request) or generate a request based on current information from the knowledge management engine discussed herein (e.g., based on current personal information that is consumed or produced by a user and associated with an AOI or AOE).

For example, the knowledge management engine may assess information within one or more user profiles and determine one or more AOIs. The knowledge management engine may apply machine learning to identify certain triggers that relate to user interests (e.g., a user drinks coffee every morning before 10 AM on nights where the user gets less than 6 hours of sleep). The knowledge management engine may further group AOIs and interests for multiple users.

Based on information from the knowledge management engine, the infuser may search for information of interest related to AOIs and the like from the MHRI 502. If there is insufficient information, the information contained within the MHRI 502 does not meet a credibility criteria (e.g., a credibility threshold), or the information contained with the MHRI 502 does not meet a probability criteria that predicts interest for any number of users (e.g., probability threshold), then the infuser may provide the information request to and/or generate a new information request for the infused crawler 506 to crawl the communication network 514 for additional information to add to the MHRI 502.

The infused crawler 506 may receive an information request based on a query from the user (e.g., to perform a user crawl 508) or receive an information request based on AOIs and/or other current interests based on one or more users' PHRI 504 and/or user profiles (e.g., to perform a dynamic crawl 510).

An infused crawler 506 may perform an infused crawl. An infused crawl comprises a search (e.g., by a crawler) for information not contained and/or pointed to by the MHRI 502). In some embodiments, an infused crawl is a search for information based, at least in part, on the decision-making or thought process of one or more users based on one or more PHRIs 504 and/or user profiles (e.g., the crawl is infused with the user's decision-making or thought process).

The infused crawl may crawl different databases, files, or networks (e.g., the infused crawl may search for information on the communication network 514 such as the Internet).

In some embodiments, the user crawl 508 is a crawl that may be performed by the infused crawler 506 based on an express direction by the user. For example, the user crawl 508 may be controlled by an information request that is generated by or based on a query from one or more users. In some embodiments, a user may provide a query or search query to the discovery system or provide queries in produced content elements (e.g., search queries to databases or queries contained in discussions or writings by the user).

In some embodiments, the infused crawler 506 may perform the user crawl 508 to retrieve information from the communication network 514

The infused crawler 506 may perform an AOI/AOE crawl. In various embodiments, the knowledge management engine may identify the most current AOIs and AOEs associated with the one or more users. For example, the knowledge management engine may order one or more user's AOIs and AOEs based on time (e.g., the most current content elements associated with one or more AOIs and/or AOEs) and/or amount of personal information (e.g., one or more users have consumed and/or produced a quantity of content associated with topics of one or more AOIs and/or AOEs that is beyond one or more thresholds). The knowledge management engine may select any number of AOIs and/or AOEs to determine the amount and quality of data associated with the selected AOIs and/or AOEs in the MHRI 502.

The knowledge management engine and/or infuser may assess information in the MHRI 502 (if any) related to the identified AOIs and/or AOEs. In some embodiments, the knowledge management engine may score content elements identified from the assessment for probability of content of interest (i.e., probability scores). The knowledge management engine may further determine if the quantity of information is sufficient (e.g., above a sufficiency threshold) to provide to any number of users regarding these topics of interest.

If there is insufficient information and/or the information associated within the MHRI 502 has probability scores that are below a probability threshold, the infuser may generate an information request for the infused crawler 506.

The infused crawler 506 may crawl any number of communication networks 514 such as but not limited to the Internet. Content 516 may be retrieved from the communication network 514. The content 516 may be decomposed (e.g., advertisements, messages, authorship, time, and the like. In various embodiments, the infused crawler 506 may initiate a crawl from the PHRI 504 if there is insufficient data to pass from the MHRI 502. In some embodiments, the PHRI 504 may initiate the process directly and the data may be split to the PHRI 504 and objectively mapped to the MHRI 502.

The NLP/decision engine 518 may perform natural language processing (e.g., utilizing open NLP and/or X-bar theory) to identify messages within the content 516 and determine context, sentiment, intent, depth, and the like. The NLP/decision engine 518 may also identify authorship, time the content was published, and the like. In various embodiments, the NLP/decision engine 518 generates credibility scores associated with the content as well as probability scores for the likelihood that one or more users may be interested in the content 516 (e.g., the probability that the content 516 will satisfy a likely interest of the user(s)).

In various embodiments, the system identifies 6Rs associated with each content 516 to determine reach, reputation, resonance, recognition, region, and range as discussed herein. In various embodiments, the knowledge management engine clusters information to identify credibility (e.g., based on deltas or differences when compared to information previously stored in the MHRI that relate to similar topics) as well as the 6Rs as discussed with regard to FIGS. 4b and 4c.

Author graphs 522 identify authors, content published by or in conjunction with an author, the author's AOEs, credibility of one, some, or all content elements associated with the author, as well as other assessments (e.g., context, sentimentality, depth, and intent) of one, some, or all content elements associated with the author.

In various embodiments, the NLP/decision engine 518, controller, or knowledge management engine may create a new entry for a previously unknown content element that is retrieved as a part of content 516. Information associated with the content element may also be stored or associated with the author graphs (e.g., credibility of the content element, context, sentimentality, intent, depth, and the like).

The PHRI 504, as discussed herein, contains or relates to personal information (e.g., content produced such as user absorbed content 532 or consumed such as user generated content 534 by a user). The PHRI 504 and/or the user profiles (such as the user matrix) may associate personal information with time periods when the content was produced or consumed. User absorbed content 532 and user generated content 534 may be clustered together to give the content additional context and/or subtext over any period of time. In one example, for any personal information, the knowledge management system may assess other personal information from the user to seek further context and/or subtext over an one hour, one day, one week, one month, three months, nine months, fourteen months, and eighteen months. The knowledge management system may assess other personal information from the user over any period(s) of time(s).

In various embodiments, the PHRI 504 may receive or be associated with new content elements associated with personal information recently received from or produced by a user. The content may come from social sites 526 (e.g., Facebook, Twitter, LinkedIn, email, or the like) and/or infused sites 524 (e.g., professional articles on professional websites or the like). Similar to the method of decomposition as discussed with regards to retrieving content related to an infused crawl, the content elements from or produced by the user are similarly decomposed.

The content of the content elements may be assessed by the NLP/intent context engine 528. The NLP/intent context engine 528 may utilize open NLP and/or X-bar theory (or any other NLP algorithms) to characterize all or part of the content elements. In various embodiments, the NLP/intent context engine 528 assesses context, sentimentality, depth, and intent of the content elements. In various embodiments, the NLP/intent context engine 528 does not determine a credibility score associated with the user absorbed content 532 or the user generated content 534 since these content elements, as opposed to content elements retrieved from the infused crawler 506, are not retrieved to provide to other users.

In various embodiments, user 6Rs 522 are assessed for user generated content 534 in a manner similar to that described with regard to FIGS. 4b and 4c as well as in a manner similar to the author 6Rs 520. After content elements associated with the user generated content 534 are decomposed and characterized, the assessments and information within the content elements may be clustered and compared to authors and/or other users to determine the 6Rs and/or characterize a level of expertise and/or intent with the topics associated with these new content elements.

FIG. 6 is a diagram illustrating an example portion 600 of the master profile 155 in some embodiments. The portion 600 shows the relationship among four Data Classification Nodes (DC's) 605 (namely, 605-A to 605-D), content elements 105 (namely, 105-1 to 105-N) associated with one of the DCNs 605 (namely, DCN 605-A), and the authors 120 (namely, 120-1 to 120-N) associated with the content elements 105 associated with the one of the DCNs (namely, 605-A).

Each DCN 605 represents an information class (e.g., topic) associated with a set of content elements 105. As shown, DCN 605-A represents information class “N” and includes a pointer 610 to the set of content elements 105 (or to the set of content element identifiers) that the knowledge management engine 240 deems to be a member of information class N. Each content element 105 (namely, 105-1 to 105-N) has pointer 620 (namely, 620-1 to 620-N) to its associated author 120 (namely, 120-1 to 120-N) as identified in the author/user catalog 165.

As shown, DCN 605-A includes a pointer 630-A to one or more higher-order DCNs 605 (not shown), a pointer 630-B to a first lower-order DCN 605-B, and a pointer 630-C to a second lower-order DCN 605-C. The second lower-order DCN 605-C includes a pointer 630-D to a third lower-lower-order DCN 605-D. The first lower-order DCN 605-B may represent a subclass (N,1) of information class N. The second lower-order DCN 605-C may represent a subclass (N,2) of information class N. The lower-lower-order DCN 605-D may represent a subclass (N,5) of information class N,2, which is a sub-subclass (N,5) of information class N. The portion 600 may include additional lower-lower-order DCNs 605 “below” DCNs 605-B and 605-C, as represented by the additional lower-lower-order pointers below each of lower-order DCN 605-B and DCN 605-C.

One skilled in the art will recognize that each lower-order DCN 605 may include a pointer to a set of content elements 105, which may be a subset of the content elements 105 of its higher-order DCN 605. Each higher-order DCN 605 may include the content elements 105 of all its lower-order DCNs 605 and possibly more. For example, the content elements 105 associated with a higher-order DCN 605 for cars would naturally cover the content elements 105 associated with its lower-order DCN 605 for engine performance and its lower-order DCN 605 ride comfort. Similarly, the content elements 105 associated with lower-order DCN 605-C would naturally cover the content elements 105 associated with its lower-lower-order DCN 605-D and possibly more.

In some embodiments, the content characterization engine 220 and/or the knowledge management engine 240 will assign a content element 105 to a particular DCN 605 based on the information class it attributes to the content element 105. If the content characterization engine 220 and/or the knowledge management engine 240 finds that a new content element 105 is insufficiently close to all existing DCNs 605, the content characterization engine 220 and/or knowledge management engine 240 may create a new DCN 605 and may associate the new content element 105 with the new DCN 605.

FIG. 7 is a diagram illustrating details of an example portion 700 of the PHRI 180 in some embodiments. As shown, the PHRI portion 700 shows the relationship of three DCNs 605. Like with the MHRI 175, each DCN 605 in the PHRI 180 represents an information class (e.g., topic) and the current interests of a user 115.

As shown, DCN 605-A includes a pointer 705-A to one or more higher-order DCNs 605 (not shown), a pointer 705-B to the DCN 605-B, and a pointer 705-C to the DCN 605-D. DCN 605-B represents the same subclass (N,1) of information class N as described in FIG. 6. DCN 605-D represents the same sub-subclass (N,5) of information class N. The PHRI portion 700 may include additional DCNs 605 “below” DCNs 605-B and 605-D, as represented by additional pointers below each of DCN 605-B and DCN 605-C.

The pointers 705 of the PHRI portion 700 may pertain to the connections a user 115 perceives between information classes, not the connections based on information class hierarchy. In other words, when selecting a car to purchase (e.g., information class N as represented by DCN 605-A), a user 115 may care about engine performance at information class N,1 as represented by DCN 605-B and ride performance at information class N,5 as represented by DCN 605-D. The user 115 may not care (or care less) about the ride performance at information class N,2 as represented by DCN 605-C, which is not included in the PHRI portion 700.

Because the PHRI 180 includes a subset of the MHRI 175, the discovery system 130 can identify content elements 105 from the MHRI 175 based on the current interests of the user 115 as defined by the PHRI 180.

FIG. 8 is a diagram illustrating details of a user matrix 800, in some embodiments. In various embodiments, natural language processing, statistical analysis, machine learning techniques, and other techniques are applied to conduct an analysis of a users' personal information and to combine that information with other information that the users' may have produced for public consumption. This information may then be used to develop a detailed profile (“matrix”) of each user and author.

The user matrix 800 may comprise an AOI/AOE correlation table 802. The AOI/AOE correlation table 802 may comprise an AOI data structure 804 and an AOE data structure 806. In various embodiments, the user matrix 800 comprises a comparison data structure 808.

In various embodiments, Areas of Interest (AOIs) and Areas of Expertise (AOEs) are determined for the user and are ranked. In one example, AOIs and AOEs are ranked based on how closely they correlate with that user's historical activity (e.g., as represented by past personal information shared with the discovery system). For example, an AOI may be identified based on an amount of personal information recently consumed or produced that is associated with a topic of interest. AOIs may be ranked, for example, based on the topics of interest associated with the most recent personal information as well as the amount of personal information (e.g., number of articles recently read and/or produced) associated with the topic of interest.

Similarly, the AOEs may also be ranked based on how closely they correlate with that user's historical activity. For example, an AOE may be identified based on an amount of personal information recently produced that is associated with a topic of interest, the credibility of the information produced (e.g., as measured by comparing the information within the personal information to the information produced by another known author of known credibility), and the 6Rs.

The ranked AOIs and AOEs and associated data may be kept in any number of data structures.

In various embodiments, for each AOI and AOE, the discovery system maintains a rank ordered list of the authors that are most relevant to the user within that AOI or AOE. A large amount of other metadata and links to metadata about the user and each AOI or AOE may be maintained (e.g., intention and credibility).

For example, the AOI data structure 806 depicts a table for including an AOI identifier (e.g., AOI name), as well as authors that are most relevant to the user with regard to the AOI. Further, the AOI data structure 806 may include AOI metadata and links (e.g., pointers) to content elements and/or metadata.

The AOI data structure 804 for a user may be constructed and maintained based on, for example, information in a user's private network, the user's contributions that are found on the public network, and user curation of content displayed to them by the system. In various embodiments, the knowledge management engine may adjust weightings, credibility, AOIs, trends, and other factors.

In another example, the AOE data structure 808 depicts a table for including an AOE identifier (e.g., AOE name), as well as authors that are most relevant to the user with regard to the AOE. Further, the AOE data structure 808 may include AOE metadata and links (e.g., pointers) to content elements and/or metadata.

In some embodiments, the AOE data structure 808 may be initially constructed by importing the user's professional network (e.g. LinkedIn) or the like. The AOE data structure 808 may also be affected by content and by the machine learning processes of the system.

In various embodiments, the AOI/AOE correlation table 802 may also contain correlation information between the AOI data structure 806 and the AOE data structure 808. In some embodiments, the AOI/AOE correlation table 802 may also contain links into the MHRI 804 including the decision tree adjustor of the MHRI 804.

The comparison data structure 808 may contain a list of differences related to each user/author. The differences may be historically calculated with other users/authors in the system. In various embodiments, a timestamp associated with each historical comparison may be maintained. In some embodiments, the discovery system may utilize timestamps to perform time-based analyses of how a user's metadata has changed relative to another user.

An author matrix may be similar to the user matrix, however, those skilled in the art will appreciate that an author who is not a user of the system will not have opted-in their personal information. As a result, the author matrix may be missing information when compared to a user matrix.

In various embodiments, there may be three major states of a user's matrix, including a user's matrix for a user who is not an author, an author who is not a user, and an author who is a user. The user matrix for a user who is not an author may reflect a user that has obtained an account on the discovery system and who has opted-in their personal information (e.g., private network information) but the discovery system has not determined if that user is also a significant author of public or private content. Those skilled in the art will appreciate that, over time, if the system determines that the user is an author, then the user's user matrix could change to reflect the user's status as also being an author. In various embodiments, there is no major change that occurs to the user matrix itself when this happens. It may merely mean that the user's degree of public authorship on the public network has crossed a threshold that the user is now considered an author.

The user matrix for the author who is not a user (e.g., an author matrix) may be developed from discovered content elements in the communication network (e.g., pursuant to an infused crawl). If the author later creates an account on the discovery system, their matrix may change to that of an “author/user.”

The user matrix of an “author/user” is for a user of the discovery system (e.g., a user who has opted-in personal information) as well as an author for content elements the author produced.

Those skilled in the art will appreciate that among the above states there a multiple sub-states. For example, a user could have some content on the Internet but not enough for them to be declared an author by the discovery system. In this case the system may categorize the user as a user who is an “emerging author.”

In various embodiments, the discovery system may maintain one or more global lists of AOIs based on unsupervised data mining and clustering by the machine learning system. Those skilled in the art will appreciate that there may be hundreds or more AOIs maintained by the discovery system. Further the discovery system may create new AOIs over time. For example, for each user, the content in their social network and the articles they have authored on the Internet may be used to rank order the AOIs based on how relevant they are to that author/user.

The discovery system may also maintain a rank ordered list of the authors that are most relevant for that user in each AOI (see AOI data structure 806). The author ranking may be based on a comparison of the user's historical behavior, content he/she may have authored in the public web or in private social media networks, and even the manner in which the user has interacted with the system versus the same information about authors. For each AOI of a user, the user matrix 800 may also maintain links to other metadata relevant to the AOIs and author/user including links to browsing history, demographics, user metadata history, NLP weightings, and others.

As discussed herein, the structure of the user's AOE data structure 808 may be similar to or different from the AOI data structure 806. The discovery system may maintain a global list of AOEs, which may be developed by an application of machine learning technologies to the professional network information that is read into the system as users opt-in their professional social/private networks (e.g. LinkedIn). In each user's matrix 800, the AOE data structure 808, may track a rank ordered list of AOEs that correspond to the expertise of the user as determined from processing of the user's public and private content. As with the AOI data structure 806, the AOE data structure 808 table may also contain a list of rank-ordered authors for each of the user's AOEs that reflect the relevance of those authors to that user/author.

In some embodiments, the user matrix 800 may also contains a data structure that correlates the user's AOEs and AOIs to each other. This data structure also contains links to the MHRI 804.

In some embodiments, the user matrix 804 of an author/user will frequently be compared to that of other author/users. Each time a user's matrix 804 is compared to another user, the differences between the users' matrices may be captured in a table contained within each user's matrix. In addition to the differences found, a timestamp may be associated with this operation. The timestamp may allow the machine learning core of the system to look at the evolution of user's user matrices as they compare to other user matrices.

A user/author comparison process may utilize a technique called “triangle modeling” which determines various “edges” to a user's connections to another user. For example, the connection among three user/authors A, B, and C may be stronger if user A is connected to users B and C. In addition, because users B and C both have connections to user A, users B and C may be also considered to have a connection to each other.

In some embodiments, the user matrix 800 may be saved periodically. The discovery system may make use of variances over time of a user's user matrix 800 to improve results. In various embodiments, like users are characterized into groups and the trajectory of their matrices is considered by the knowledge management engine to aid in predicting areas of interest for the group. Further, profiles of other users who have followed a similar trajectory in the past may be used to predict how a user's preference might trend in the future.

For example, if many users have trended from state A, to state B, to state C and a particular user has already transitions from state A to state B, then a slightly higher weight may be given to discoveries and search results for that user if those results would trend closer to state C.

Those skilled in the art will appreciate that a comparison may attempt to determine divergences in intention and interest as it relates to specific AOIs. Differences that arise from the comparison may be used to re-examine a portion (e.g., 90%) of the content that the discovery system crawls that it determines to not be relevant. If the discovery system determines that there are content elements within the portion of information that is rejected by the crawler that are relevant to the difference between the two users, then those content element may be “re-admitted” to the discovery system. The matrices for the two users may be re-built including the “re-admitted” content elements. Entries for the “re-admitted” content may be added to the MHRI and to PHRIs as appropriate.

In some embodiments, the time intervals that provide the greatest significance for this trending function follow a gradually increasing spacing. For example for some users applying this trending function has proven to be optimal if the version of the matrix at the following intervals are consulted:

1) One week

2) One month

3) 4 Months

4) 9 months

5) 16 months

6) 20 months

The optimum intervals depend on the specific of the data being examined.

In addition to the above technique, the discovery system may provide a lower weight to certain inputs that are generated in certain months that coincide with vacations. This weighting may vary by region and by the regional's local culture and customs. For example, in the northern hemisphere, lower weightings may be applied to the month of August.

While the above describes matrices as being primarily about users or authors, the discovery system may also create matrices for brands. The contents of a matrix for a brand may be very similar to that of a user and author. However, a brand may not produce content elements with intention, sentiment, sarcasm, or the like. As a result, content elements produced by a brand may be assessed in a different manner than content elements produced by a user.

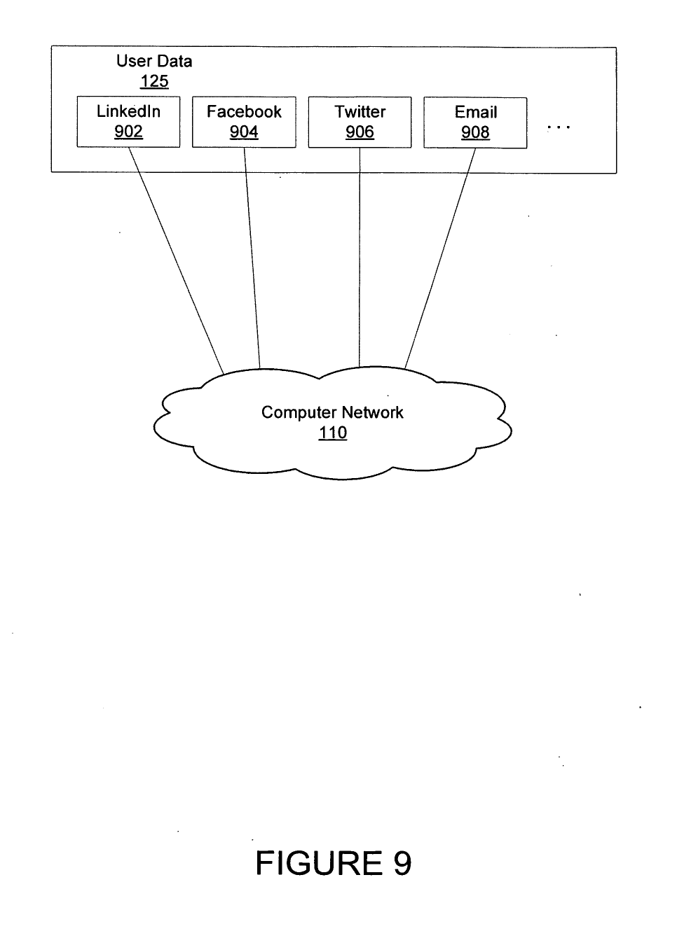

FIG. 9 is a diagram 900 illustrating details of user data in some embodiments. In various embodiments, a user may “opt in” any user data to include the data within the discovery system 130. The discovery system 130 may utilize any or all of the data to determine interests, AOIs, AOEs, or the like. The information that is authorized by the user 115 to share with the discovery system 130 may be utilized to assess context, intent, sentiment, depth, and any other characteristics of content as well as topics of interest to better understand the user 115, identify content elements of predicted interest, or the like.

User data 125 may comprise any personal information including data from personal networks (e.g., social networks) as well as public websites. In various embodiments, users 115 may “opt in” or otherwise allow personal data to be discovered by the system. Personal data, regardless of whether the personal data is intended to be private or public, may include, but is not limited to, content generated by the user (e.g., social network entries, email, text messages, queries, web pages, documents, pictures, movies, audio files, and the like) as well as content consumed by the user (e.g., articles, email from others, tweets reviewed, RSS content consumed, Facebook entries reviewed, social games played, or the like).

For example, personal information can be any information the user consumes or produces that is accessible by a communication network 1004. Examples of social networks that the user may allow the discovery system 130 to access include LinkedIn 902, Facebook 904, and Twitter 906. Those skilled in the art will appreciate that the user 115 may allow information to be shared by any social network. Personal information may also be shared including data from email accounts 908, or the like.

Generally, a user may allow personal data from many different sources to be discovered by the system 130. A source is any website, service, and/or database that receives from or provides personal data to a user 115. For example, sources may include LinkedIn 902, Facebook 904, Twitter 906, email 908, and Google Search. In some embodiments, the discovery system 130 is configured to utilize APIs (e.g., streaming APIs) to retrieve the user's information from the social networks, accounts, websites, or the like. Those skilled in the art will appreciate that there are many ways for the discovery system 130 to retrieve information from different sources. The discovery system 130 may direct the personal information to a user's PHRI 140 and/or user profile 135.

In various embodiments, an agent loaded on a user's digital device may be configured to provide personal data to the discover system 130 based on the user's consumption of data (e.g., articles read), games played, or other activities. The agent, in various embodiments, may be configured by the user to selectively provide personal data (e.g., copies of personal data) to the system and/or be configured to analyze and/or access the personal data.

For example, a user may opt-in personal data that is submitted to and retrieved from Facebook 904. In various embodiments, a discovery engine 130 may receive data associated with Facebook 904. In some embodiments, the discovery engine 130 may retrieve data associated with a user's account from Facebook 904 (e.g., from Facebook servers). The discovery system 130 may intercept data sent to and/or data retrieved from Facebook 904 (e.g., an agent on a user's digital device may copy and/or intercept data being sent to and/or retrieved from one or more social networks).

In various embodiments, the discovery engine 130 utilizes APIs to access Facebook 904 or any other service or account to obtain personal information.

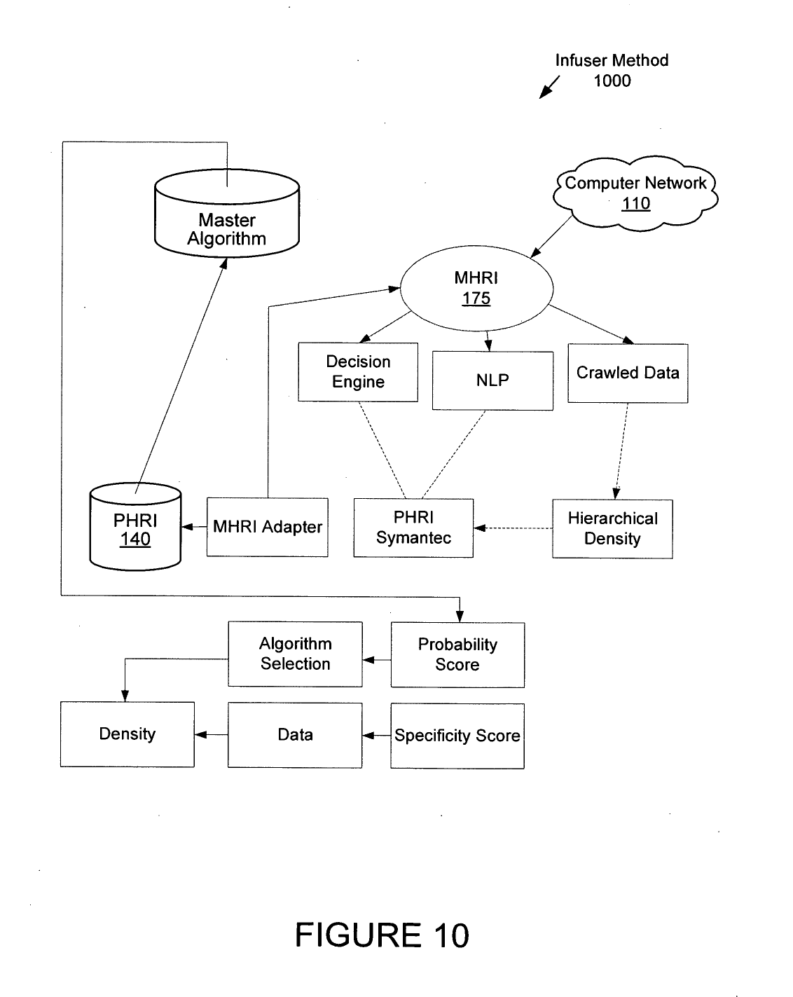

FIG. 10 is a diagram illustrating details of an infuser method 1000, in some embodiments. At a high level, the infuser and/or knowledge management engine identifies a current interest (e.g., an AOI) of at least one user based on content that the user has produced or consumed. The infuser and/or knowledge management engine may subsequently determine if there is sufficient, credible, and relevant information within or tracked by the MHRI 1004 that is related to the current interest. If there is insufficient information, the infuser may instruct the infused crawler to crawl a communication network 1002 to retrieve relevant content elements (e.g., crawled data 1010). The retrieved content elements may be assessed for credibility, intent, depth, sentiment, context, and/or the like. In one example, the content elements are assessed for the 6Rs; all or some of the information related to the 6Rs may subsequently be utilized, for example, in determining the credibility score.

In some embodiments, a user may generate a request (i.e., a symantec) for information. The request may be, for example, from the PHRI 1018 (e.g. an express request from the user indicating one or more interests) or any other source (e.g., the knowledge management engine may identify a trigger associated with one or more interests; the knowledge management engine may also detect a condition that satisfies the trigger). The decision engine 1006, the natural language processing engine 1008, and/or X-Bar theory determine intent of the request. The infuser may change or alter the symantec (e.g., request) to create a personal hierarchical symantec based on intent. In some embodiments, the personal hierarchical symantec may be used as at least a part of the information request for the infused crawl.

The hierarchical density 1014 may assess the density of information in the symantec to parse topics of interest and identify context and depth (e.g., to form the personal hierarchical symantec). The MHRI adapter 1016, PHRI(s) 1018, and master algorithm 1020 may review content in the MHRI 1004 and the PHRI 1018 associated with the symantec. For example, the PHRI 1018 may be examined for one or more users interest in the content request from the symantec, and the user(s) related PHRI(s) 1018 may be assessed to see how the interest changes over time to provide context for the symantec.

Any length of time durations may be utilized to assess how one or more users engagement with the interest changes over time (and why). For example, the master algorithm 1020 may examine data added to a user's PHRI 1018 over a day, a week, a month, over three months, and the like. Content added to the PHRI 1018 during each duration may be assessed for relations with the symantec. Over one duration, the user may be highly interested in information associated with the symantec, and, as such, the user may have consumed and/or produced considerable content associated with the symantec. Other time durations may indicate that the user has less information or may have the same information but the duration of time may dilute the intensity of the interest if the interest was not consistent.

In various embodiments, users regarding the symantec may be clustered together. The clusters of users may be assessed to compare to groups of users and how the data is engaged in different manners. The probability score 1022 may score the proximity of interest of the user based on the symantec and/or the user's activities as referenced in the user's PHRI 1018 when compared to different clusters. The algorithm selection function 1024 may select algorithms to assess and re-assess proximity of the user's interests in the different time duration as compared to the clusters. The specificity score 1030 may score the degree of specificity or generalness of the user's interaction with the interests associated with the symantec.

The data caches of the data 1028 may retrieve active data from cache from the different users (e.g., including the members of the different clusters). In some embodiments, the validity of the data from the data cache may be examined before being passed to the density 1026. Those skilled in the art will appreciate that validity examination may occur on data from social networks that may not be credible.

In various embodiments, the data 1028 may determine the message communicated by the user based on the information in the user's PHRI 1018 over time and relation to clusters of other users' interests The density 1026 determines the density of the information around the topic of interest.

Utilizing the comparison of interests to different clusters as well as the user's interest over time, the master algorithm 1020 may generate an information theory graph that connects points for related areas over time to identify root causes for interests over time. The information indicating the context for the interest of the symantec may be utilized to generate an information request that may more accurately reflect a predicted interest. The information request may be used to identify an amount of credible data stored within the MHRI 1004. If there is insufficient, credible data related to the information request, the infused crawler may crawl the computer network 1002 for crawled data 1010.

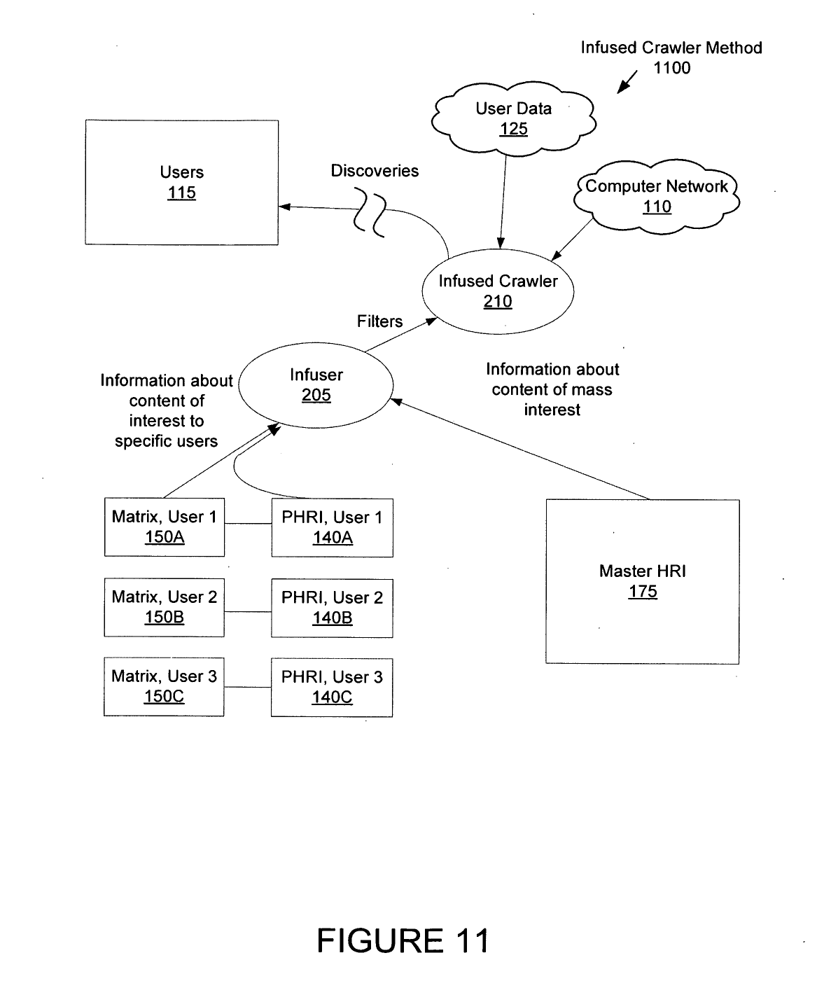

FIG. 11 is a diagram illustrating details of the infuser 205 and infused crawler 210 in some embodiments. As shown, the infuser 205 communicates with the infused crawler 210, which is capable of crawling user data 125 and the computer network 110. As shown, the infuser 205 is capable of retrieving information about content of mass interest (e.g., hot topics or trends) from the MHRI 175 and information of specific interest from various user PHRIs 140 (namely, PHRI 140A of user 1, PHRI 140B of user 2, and PHRI 140C of user 3) and associated user matrices 150 (namely, user matrix 150A of user 1, user matrix 150B of user 2, and user matrix 150C of user 3). As stated herein, the infuser 1205 infuses the infused crawler 210 with filters based on the specific interests identified and based on the mass interest identified. The infused crawler 210 then searches the computer network 110 for content elements 105 (“Discoveries”) based on the filters to satisfy the interests of the users 115.

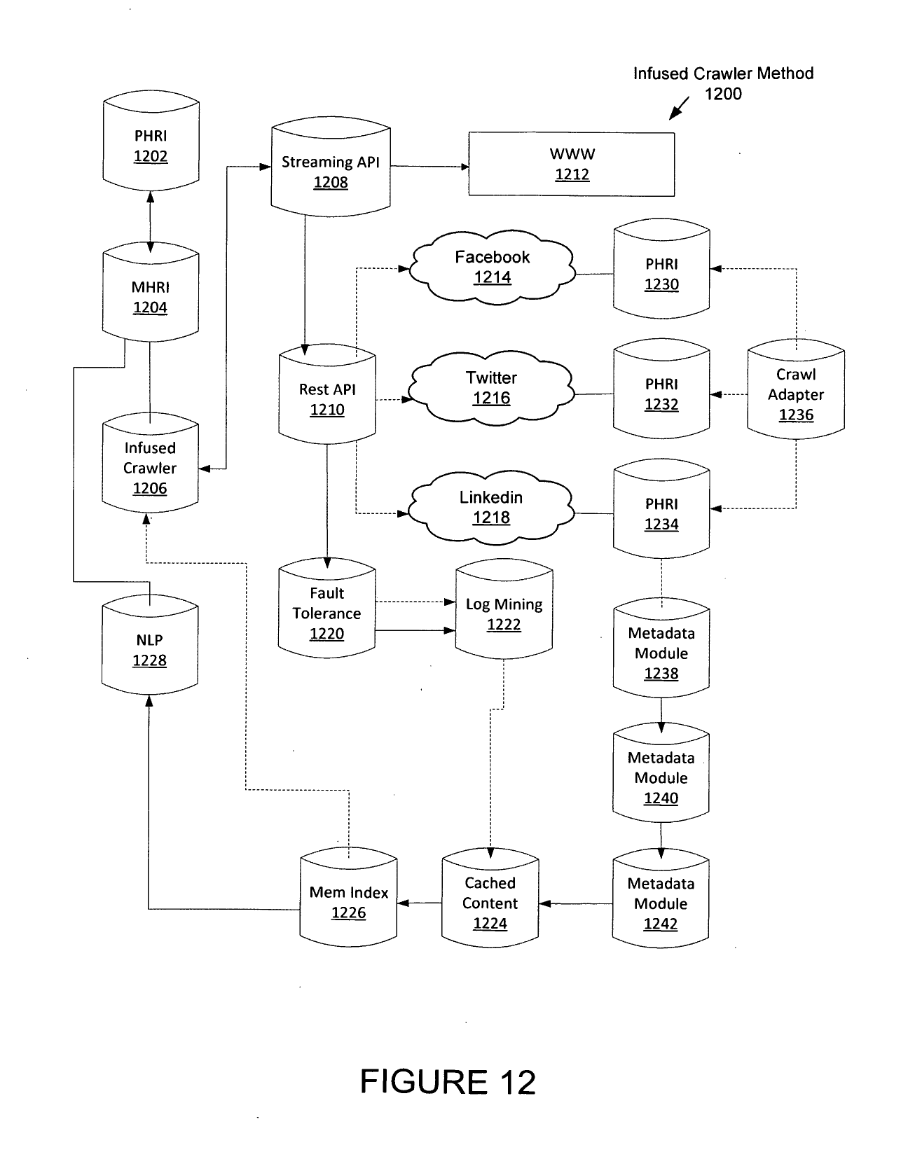

FIG. 12 is a diagram 1200 of a process for infused crawling in some embodiments. Diagram 1200 comprises PHRIs 1202, MHRI 1204, infusion crawler 1206, streaming module 1208, rest module 1210, communication network 1212, social networks 1214-1218, fault tolerance module 1220, log mining module 1222, cached content module 1224, memory index module 1226, NLP 1228, PHRI metadata modules 1230-1234, crawler adaptor 1236, and PHRI metadata modules 1238-1242.

The PHRIs 1202 may include any number of PHRIs. In various embodiments, the diagram 1200 comprises a plurality of user profiles, each of the user profiles comprising at least one PHRI and an associated user matrix. PHRIs, user profiles, and user matrices are discussed herein. Each PHRI of the PHRIs 1202 may comprise pointers to a subset within the MHRI 1204.

The MHRI 1204 comprises content elements and/or pointers to content elements that were previously retrieved from the communication network 1212. In various embodiments, content of the MHRI 1204 has been assessed for credibility and/or sentiment, depth, intent, and the like.

In various embodiments, a knowledge management engine (discussed herein) generates a request for relevant content of interest for at least one user. For example, the knowledge management engine may comprise a machine learning engine that identifies patterns of behavior and assists in defining triggers and actions for one or more users. A pattern recognized by the knowledge management engine may be, for example, a recognition that most times a user has less than five hours of sleep, the user purchases coffee before 9 AM. The machine learning engine and/or other components of the knowledge management engine may define a trigger as being when a user has less than five hours of sleep, the discovery system is to provide information regarding coffee shops that are accessible to the user. Other factors such as type of coffee, vehicle available of the user, geographical location of the user's home, geographical location of the user's place of work, path taken to work, acceptable detours to obtain coffee, likelihood of friends at coffee shop, coffee shop environmental factors, or any combination of the above may be taken into account in defining the type of information of interest to be provided to the user as well as the trigger(s).

The knowledge management engine may detect a trigger and generate a request for relevant content of interest for at least one user. In some embodiments, the knowledge management engine receives a user query relevant content of interest. The knowledge management engine may generate a request for relevant content of interest or utilize the user query as the request.

In various embodiments, the knowledge management engine may retrieve information from the MHRI 1204 that is relevant to the request for relevant content of interest. As discussed herein, information from the MHRI 1204 is associated with credibility scores. The knowledge management engine may, in some embodiments, generate a probability score to determine the likelihood that the content from the MHRI 1204 is of likely interest to the user in view of the request. If the probability scores and/or the credibility scores are not sufficient when compared or associated with one or more probability/credibility thresholds, the knowledge management engine may determine that there is insufficient information of sufficient credibility and/or probability to provide in response to the request.

The knowledge management engine may configure the infused crawler 1206 to crawl one or more communication networks 1212 for additional information based on the request for relevant content of interest. The communication network 1212 may include the Internet and/or any other networks (e.g., private networks, public networks, enterprise networks, social networks, or the like).

In various embodiments, the infused crawler 1206 is configured to crawl a communication network 1212 (e.g., Internet) based on the crawler parameters received from the infuser. The infused crawler 1206 may comprise multiple crawlers that may operate in parallel to retrieve information for one or more users.

The infused crawler 1206 may retrieve information from social networks 1214-1218 over the communication network 1212. A social network is any website or combination of websites that allow multiple users to publicly and/or privately interact (e.g., within the limits defined by the user such as with a limited number of other users or with the public at large). The PHRI 1202 may receive any kind of personal information including personal information retrieved from or sent to email servers, text servers, RSS servers, webservers, and/or the like.

The infused crawler 1206 may communicate over streaming APIs to access information from different sources over the communication network 1212. In some embodiments, certain websites and/or services (e.g., select social networks) may allow for streaming APIs to access and/or retrieve information. For example, the infused crawler 1206 may comprise a plurality of streaming APIs which allow of simultaneous connections with a single source (e.g., Facebook) and/or multiple sources (e.g., Facebook 1214, Twitter 1216, LinkedIn 1218, email servers, RSS feeds, query entries, chats, and the like).

One or more parsers may receive information from the streaming APIs to parse data flow. In various embodiments, each parser reviews header information and parses data flow based on the header information.

Those skilled in the art will appreciate that information may be retrieved from public sources (e.g., CNN, publicly available blogs, sources that publish product reviews) while other information may be retrieved from sources that include both private and public portions (e.g., social networks such as Facebook, Twitter, and LinkedIn). In various embodiments, information from public sources may be decomposed and characterized as discussed herein (e.g., by the decomposition module and the content characterization module). Information from public sources may be associated with credibility scores based on an assessment by the NLP module 1234 (e.g., through natural language processing, X-Bar, and or the like).

Information from sources that include both private and public information may be classified (e.g., metadata may be associated with the information) as either private or public by the rest module 1210 (e.g., utilizing a rest API and/or the fault tolerance module 1220). Public information from these sources may be treated as information from other public sources (e.g., associated with credibility scores). Private information may be characterized as private. In some embodiments, the private information may not have credibility scores (e.g., the information is not assessed with credibility scores by the NLP module 1234 since the information is private) however, confidence is high regarding the author(s) of the information. For some public content elements, confidence of authorship may be low (e.g., the authors are not identified by the content elements in question) even if the credibility score is relatively high.

In various embodiments, the fault tolerance module 1220 may keep information from public and private portions of websites from “polluting” each other. As discussed herein, the fault tolerance module 1220 may associate data from such websites as either public or private. The fault tolerance module 1220 may, in some embodiments, flag information in order to track that information with credibility scores. The fault tolerance module 1220 may execute analytics and filters received information.

Those skilled in the art will appreciate that the fault tolerance module 1220 or any module may characterize information from articles retrieved from the network 1212, characterize metadata associated with those articles, and normalize the information and metadata. In some embodiments, the fault tolerance module ensures data structures are properly formatted and may function as a load balancer for data types.

The log mining module 1222 may determine the location of one or more users based on users' PHRIs, information opted-in (e.g., from the user's social networks, email, cellular phone use, or GPS coordinates), user's location when the request for content of interest was generated, and the like.

For example, the knowledge management engine may generate a request (for the infused crawler 1206) for coffee utilizing the user's location. The knowledge management engine may also direct the infused crawler 1206 to query open table, yelp, google, and Bing. The knowledge management engine may generate the request and include limitations based on the user's location as well as appropriate distance from the user (e.g., within walking distance of the user).

Information retrieved by the infused crawler 1206 may be decomposed and characterized prior to correlation. For example, after information is retrieved from a web page, the information may be characterized by the NLP 1234 and associated with the characterization module which may, for example, examine content based on any criteria such as, but not limited to, the six Rs discussed herein. Different information may then be assigned with a probabilistic score to determine the likelihood of interest to the user(s).

In various embodiments, a content selection engine may select relevant content of interest based on the most accurate (e.g., most credible) data that was retrieved from the MHRI 1204 and/or the intrusion crawler 1206's retrieved information. The information may be cached by the cached content module 1224 for the user's request and/or for other requests for other users. In some embodiments, the cached content module 1230 may store information from past searches for information (from the MHRI 1204 and/or the communication network 1212). The information stored by the cached content module 1224 may be utilized to determine the probability that the cached information would be of interest to other users.

In various embodiments, between the PHRIs 1230-1234, there may be one or more delta-examine module(s) which may interface with the rest API 1210 to assist in ensuring there is no duplication of data. The information within the delta-examination module(s) may be populated every time a user logs on from the PHRI 1202 based on data trends which have already populated the MHRI.

Those skilled in the art will appreciate that some information discovered by the discovery engine 1202 may be of immediate use. For example, information retrieved by the discovery engine 1202 may include an email written by a user and consumption of articles by the user. The email and articles may relate to a product that is of interest to the user at the time the email was written and the articles consumed. This timely information may be used as a basis to find related information that may be of interest to the user. In some embodiments, the cached content 1224 may store content elements that are likely to be used within a predetermined period of time.

In some embodiments, personal information retrieved (e.g., by the crawler adaptor 1236) from social networks may include information provided by the user with the user's friends. For example, the user may have identified friends (e.g., other users). Information shared by the user and the user's friends that is opted-in by the user (e.g., Facebook entry shared with a friend in the Facebook 1214) may be retrieved from different user PHRIs 1230-1234 (e.g., user and friend PHRIs) by the crawler adaptor 1236.

In the example where the user is interested in coffee and/or coffee shops proximately located to where the user is or where the user will be, the crawler adaptor 1236 may retrieve relevant information (e.g., other coffee reviews) associated with the user's friends. In some embodiments, the crawler adaptor 1236 may retrieve information provided from the user to one or more friends or retrieve information shared with the user by the one or more friends. As a result, discussions regarding coffee, interests in coffee, coffee preferences, and coffee shops may be included and assessed (e.g., assigned a probabilistic score). In some embodiments, discussions by friends or content generated or consumed by friends may be assessed for relevant information to improve the formation of the information request that controls the behavior of the infused crawler 1206.

The PHRI metadata modules 1238-1242 may characterize information retrieved by the crawler adaptor 1236. For example, the PHRI metadata modules 1238-1242 may format the information by adding metadata regarding the source (e.g., credibility or professionalism of the source) and any other information that may assist in determining probability of likely interest or associated information regarding context, depth, intent, and/or sentiment. For example, information from Facebook may be considered casual information (potentially associated with an AOI) while information from LinkedIn may be considered more professional or potentially associated with an AOE. The PHRI metadata modules 1238-1242 may associate metadata with content from the user's or friend's profile and/or PHRI by adding metadata associated with content, intent, or the like in order to understand the user or friend's mindset.

Information from the crawler adaptor 1236 may be further associated by the log mining module 1222. For example, the log mining module 1222 may track the user's location and/or the friends locations to further refine the degree of relevance (e.g., probability score).

The controller may build behavior models based on time slices thereby clustering AOEs and AOIs. In some embodiments, brands may be associated with one or more AOE for clustering. An AOI, for example, may be clustered with, for example, other users (e.g., users with similar tendencies of drinking coffee at similar times or associated with similar events such as when there is lack of sleep). In this example, a person's matrix may match another person's matrix for this information. In some embodiments, the knowledge management engine may determine that a trigger (e.g., sleep less than 5 hours) is associated with an interest (e.g., coffee).

In various embodiments, the request for the infused crawler 1206 may be updated and/or the results from the infused crawler 1206 may be filtered at any time. For example, multiple users may request similar information and the request may be modified to retrieve information for multiple users. For example, a request for a user to find coffee in a general location may be formed. If another person requests coffee but in a more limited area, changes to the request may be made if the same request may retrieve information relevant to more users. Similarly, the request may be broadened to accommodate the needs of more users.

In some embodiments, the request is sufficiently broad and the results of the crawl may be filtered. For example, the results may cover a larger geographical area for coffee beyond the request of the first user. As a result, a filter may be engaged to provide only those results that are in the area needed by the first users. The same results may be utilized to provide information to other users that do not require the filter (e.g., the results of the request are not filtered for others). Similarly, results of the crawl may be filtered differently by different users.

Searches and/or requests for data may be curated to remove noise. In various embodiments, users curate their own interests by consuming or ignoring data that is initially considered by the system as being relevant content of interest. If information is provided that is ignored, changes may be made to the user's AOIs, AOEs, or other characterizations (e.g., in the user profile) to provide better results in the future.

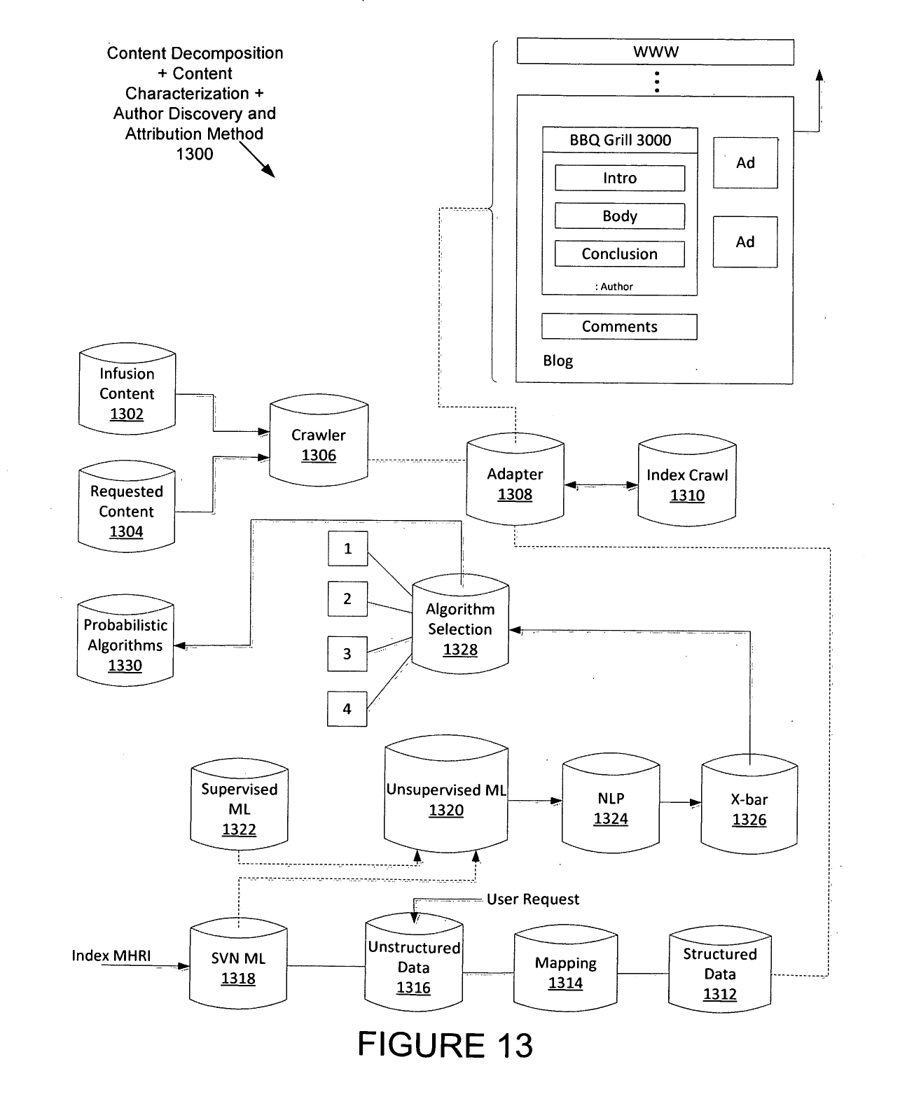

FIG. 13 is a diagram 1300 illustrating details of content decomposition, content characterization, and author discovery and attribution in some embodiments. In various embodiments, the infused crawler 1306 receives an information request. The information request may be generated dynamically (e.g., from the infusion content 1302 generated by the infuser and the knowledge management engine as discussed herein) or from a user request for content (e.g., from the requested content 1304). The infused crawler 1306 may crawl a communication network for content elements.

The adapter 1308 decomposes a content element (e.g., a webpage on a website) retrieved by the infused crawler 1306. For example, the infused crawler 1306 may retrieve and/or identify a webpage. Although a webpage is identified in FIG. 13, those skilled in the art will appreciate that the infused crawler may retrieve and/or identify any content (e.g., blog, email, text message, tweet, part of a webpage, multiple webpages, or the like).

In various embodiments, the adapter 1308 decomposes the content received by the infused crawler 1306 into portions likely to have content of interest. For example, the content retrieved from the communication network may comprise advertisements, references to other websites, or other portions that are not of interest.

The adapter 1308 may scan (e.g., x-ray) the content received from or identified by the infused crawler 1306 to identify different portions of the content element. For example, the adapter 1308 may identify how the webpage is broken down based on tags (e.g., HTML tags, flash tags, or other visualization tools), links, SQL code, and the like utilizing an index crawl 1310. The adapter 1308, for example, may identify and disregard advertisements, text, or pictures that are not related to content of interest. The adapter may identify a title, introduction, body, conclusion, comments, and the like (e.g., via tags or other information which indicate how the content is broken down).

In various embodiments, the adapter 1308 may compare the content of the relevant portions to entries in the MHRI. For example, the adapter 1308 may compare words that are often used in the article to compare entries in the MHRI to the content of the web page and then map the content relative to the compared entries utilizing the structured data 1312 and the mapping 1314. In one example, the adapter 1308 may hash content from the portions to compare with hashes of index nodes within the MHRI to identify structured data 1312 associated with the content. In various embodiments, supervised machine learning 1322 identifies relationships based on the mapping 1314 (e.g., the comparison of content from the retrieved portion to nodes within the MHRI).

The SVN module 1318 may view the content from the portion as unstructured data 1316 in view of the AOI or AOE associated with the original request. In one example, the SVN module 1318 pay perform a logical regression to determine the root of words and phrases to provide to the unsupervised machine learning 1320. The unsupervised machine learning 1320 takes the relationships identified by the supervised machine learning 1322 as well as the roots and relationships from the SVN machine learning 1318 and associates a variable cross reference with the MHRI based on the AOI(s) or AOE(s) associated with the request.

In one example, language from the portion retrieved by the adapter 1328 may match from a probability standpoint a structured model built for the existing MHRI. In some embodiments, the NLP 1324 and x-bar 1326 assess all or part of the content from the portion to identify an appropriate algorithm from the algorithm selection 1328 to identify a preexisting structured model for the MHRI. The probabilistic algorithms 1330 may assess the probability of association with the selected model. The unsupervised machine learning 1320 may utilize a probable model to determine context and subtext. For example, although the terms BBQ and grill may be throughout the portion of content, the application of the model to the content of the portion may indicate an intended message (e.g., intent) of “quality” even though the term “quality” does not appear in the article.

Utilizing this information, the discovery system may assess the probability score to determine the likelihood of information of interest to one or more users in view of the discovered context. In various embodiments, the discovery engine may further assess credibility and perform author matching as described herein.

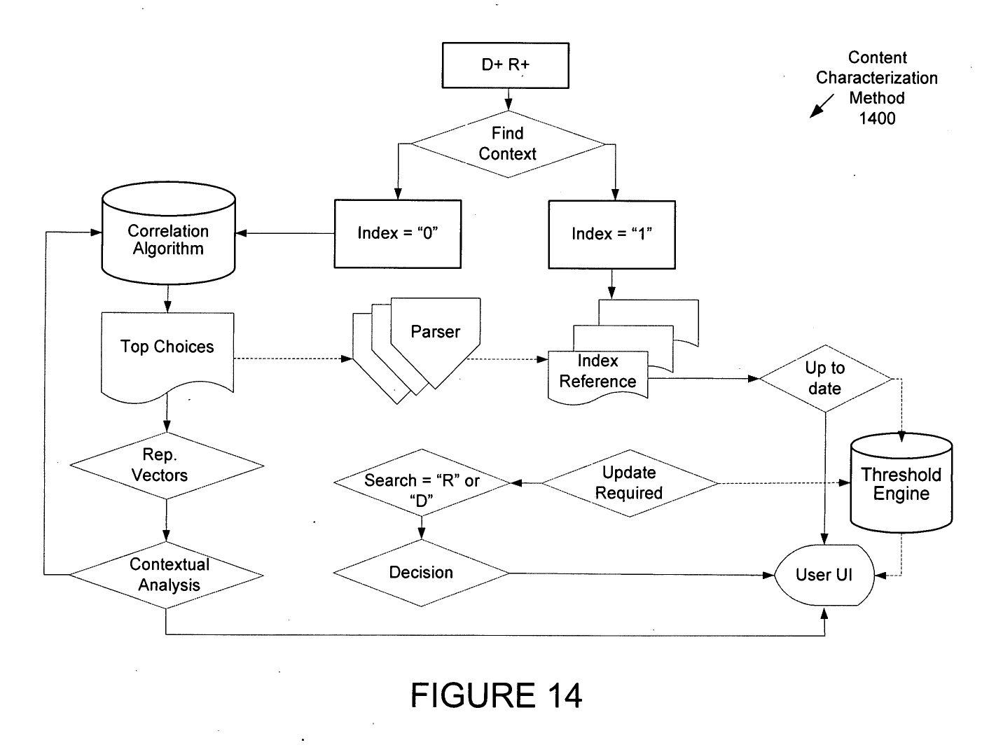

FIG. 14 is a diagram illustrating a method 1400 of how the content characterization engine 220 (in cooperation with the knowledge management engine 240) characterizes a new content element 105 to fit into the MHRI 175, in some embodiments.

Generally, the content characterization engine 220 determines if the new content element 105 belongs to one of the existing DCNs 605. In some embodiments, the content characterization engine 220 compares the context of the new content element 105 against the context of one or more of the content elements 105 associated with one or more DCNs 605. In some embodiments, the content characterization engine 220 compares the context of the new content element 105 against metadata associated with one or more DCNs 605. If threshold similarity is found, the content characterization engine 220 associates the new content element 105 with the DCN 605. Otherwise, the content characterization engine 220 creates a new DCN 605 within the MHRI 175 for the content element 105.

As shown, for a new content element 105, the content characterization engine 220 performs a context-based analysis to determine if the new content element 105 matches an existing DCN 605. If not, then the content characterization engine 220 goes “left.” If so, then the content characterization engine 220 goes “right.”

If the content characterization engine 220 determines that a match does not exist, then in the box labeled “Correlation Algorithm,” the content characterization engine 220 correlates the new content element 105 with other DCNs 605 to find the DCNs 605 of closest match (shown as “Top Choices”). The content characterization engine 220 calculates the conceptual distance (shown as “Rep. Vector”) between the new content element 105 and the top choices. The content characterization engine 220 creates a new DCN 605, associates the new content element 105 with it, and positions the new DCN 605 into the MHRI 175 with pointers to the top choices.

If the content characterization engine 220 determines that a match exists, then the content characterization engine 220 adds the new content element 105 to the set of content elements 105 associated with the DCN 605. The content characterization engine 220 also updates the metadata of the DCN 605 to reflect the addition of the new element. In some embodiments, the content characterization engine 220 may also update PHRIs 180 that reference the updated DCN 605, if needed.

If the content characterization engine 220 determines that the new content element 105 matches the user request for a certain user 115, the content characterization engine 220 can present the new content element 105 to the user 115 through the user interface (shown as “User UI”).

In various embodiments, parsers may parse new content elements 105. A parser may comprise a load balancer which can spawn multiple parsers based on the number of choices presented due to daily MHRI trends.

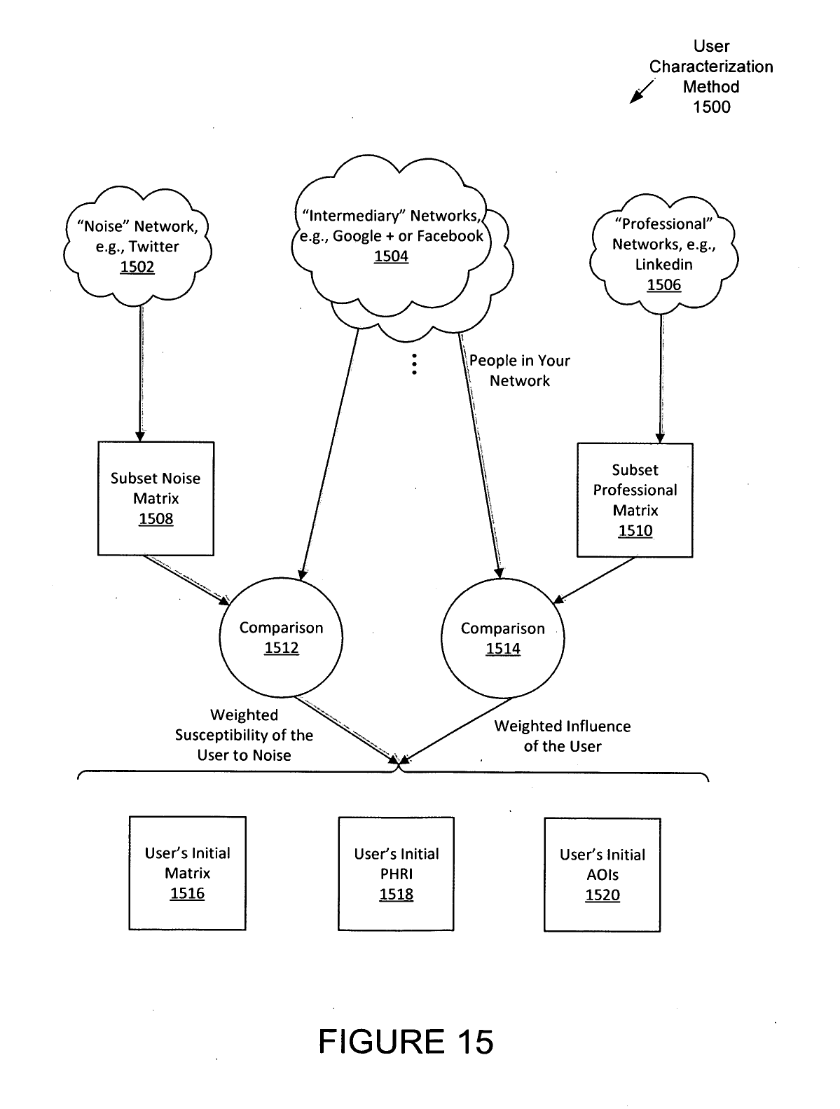

FIG. 15 is a diagram illustrating a method 1500 detailing how the user characterization engine 220 evaluates user data 125 to assist with creation of initial versions of the user matrix 1516, PHRI 1518, and AOIs 1520. In some embodiments, the user characterization engine 220 does not deal with all user data 125 in a uniform way. The user characterization engine 220 may categorize user data 125, as shown, into noise networks 1502, professional networks 1504, and intermediate networks 1506. The user characterization engine 230 runs these processes when either a new user 115 joins the discovery system 130 and opts-in, or when a new author 120 is discovered as a result of a newly discovered content element 105 from the computer network 110.

In some embodiments, the user characterization engine 220 treats LinkedIn, which contains information about people's careers and their interactions with other professionals, as a professional network 1506. The user characterization engine 220 may consider information from professional networks 1506 as more reliable, objective, and stable. The user characterization engine 220 may use the user data 125 from a professional network 1506 as a source about a user's expertise.

In some embodiments, the user characterization engine 220 treats Twitter, which contains short comments or reactions of a user to public events, content, products, or other user's comments or “Tweets,” as a “noise” network 1502. Other examples of noise networks 1502 include micro-blogging sites, Jabber and Instant Messaging Tools. The user characterization engine 220 may consider information from noise networks 1502 as less substantive and objective. The user characterization engine 220 may use the user data 125 from noise networks 1502 as a source about a user's credibility, susceptibility to marketing messages, content propagation behaviors and tendencies, as other factors.

In some embodiments, the user characterization engine 220 treats Facebook and Google+, which contains more persistent content about a user 115, as an “intermediate” network 1504. The user characterization engine 220 may user the user data 125 from intermediate networks 1504 as a source about a user's current interests, identification of friends, more accurate social identity, etc. The user characterization engine 220 may also evaluate the user data 125 of the user's friends, especially those that overlap with the user's professional network 1506, to determine commonalities.

The user characterization engine 220 compares 1512 the user data 125 from noise networks 1502 against the user data 125 from intermediate networks 1504 to determine the user's susceptibility to noise. The comparison(s) 1512 may include comparisons against the user's data 125 and/or against cohort user data 125 (assuming that the cohort data has been opted in). The user characterization engine 220 uses the results of the comparison(s) 1512 to assist with determining user credibility as to the user's AOIs and/or AOEs.

The user characterization engine 220 compares 1514 the user data 125 from the professional network 1506 against the user data 125 from the intermediate network 1504 to determine the amount of influence cohorts have on the user's AOIs and AOEs. The comparison(s) 1514 may include comparisons against the user's data 125 and/or against cohort user data 125 (assuming that the cohort data has been opted in).

The user characterization engine 220 compares the results of the two comparisons 1512 and 1514 to determine common areas that regularly show up, to determine user AOIs, to identify who influences the user 115, to determine how cohorts and noise affect a user 115, etc.

The user characterization engine 220 enables the knowledge management engine 240 to create the initial PHRI 140 and user matrix 150 for the user 115. The user characterization engine 220 and/or knowledge management engine 240 will regularly revise the PHRI 140 and user matrix 150 as the user characterization engine 220 identifies and evaluates newly discovered content elements 105 of the user 115, determines and evaluates the credibility of the user 115 in each AOI and/or AOE, the user's cohorts credibility in related AOIs and/or AOEs, consumption and production behavior, user curation behavior, etc.

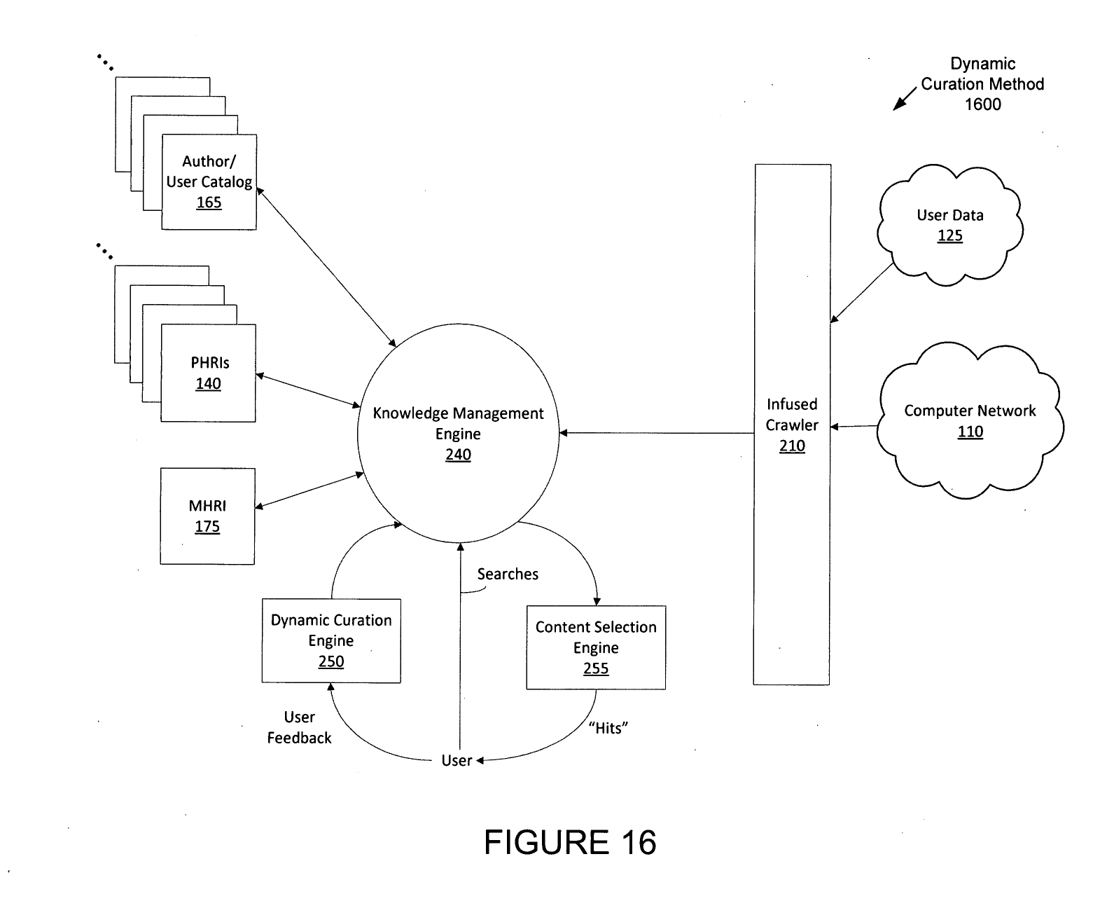

FIG. 16 is a diagram illustrating details of a dynamic curation method 1600 in some embodiments. Possibly in response to an express search and/or a dynamic search, the infused crawler 210 locates new content elements 105 from computer network 110. The infused crawler 210 passes the new content elements 105 to the knowledge management engine 240, which updates the MHRI 175, PHRIs 140 and/or author/user catalogs 165 with the new content elements 105.

Upon detecting new content elements 105 that match a user's request (express or dynamic), the content selection engine 255 provides the discoveries (“Hits”) to the user 115. The dynamic curation engine 250 monitors user feedback (user curation, curation behavior, etc.) and reports its findings back to the knowledge management engine 240, which updates the MHRI 175 and PHRIs 140 to revise current interests, AOIs, AOEs, sentiment, intentions, depth and/or the like.

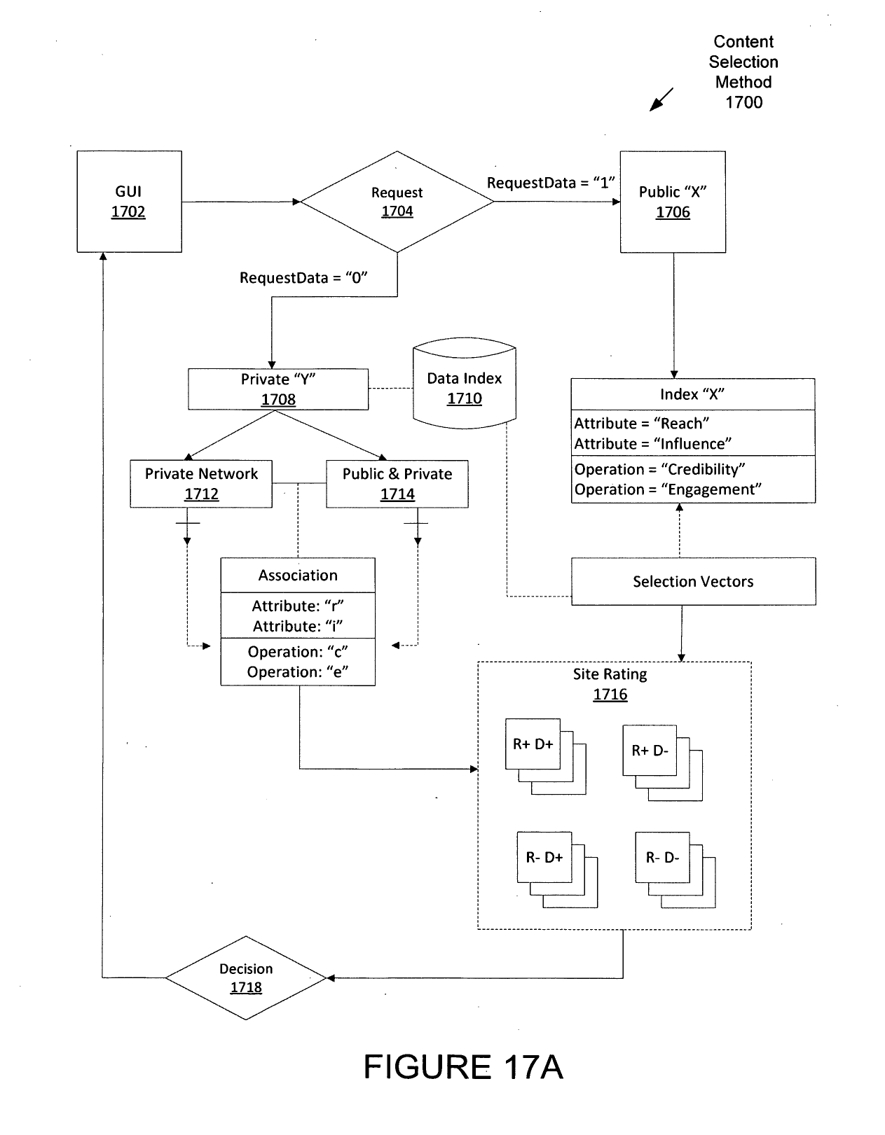

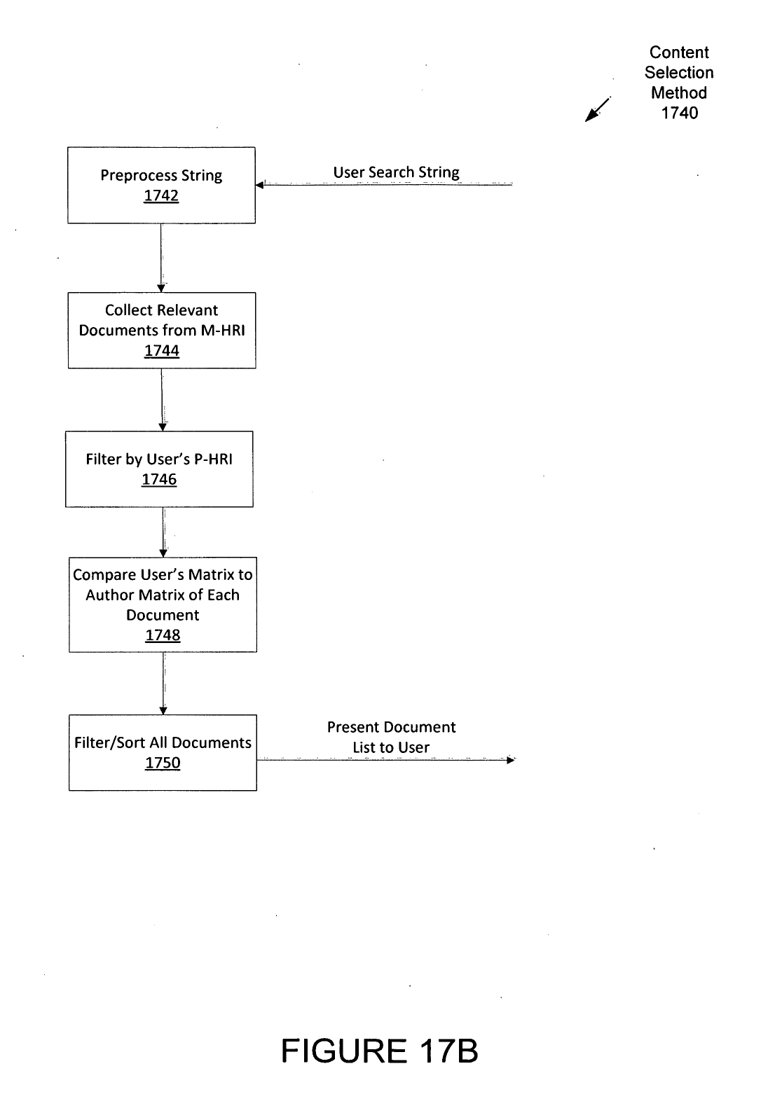

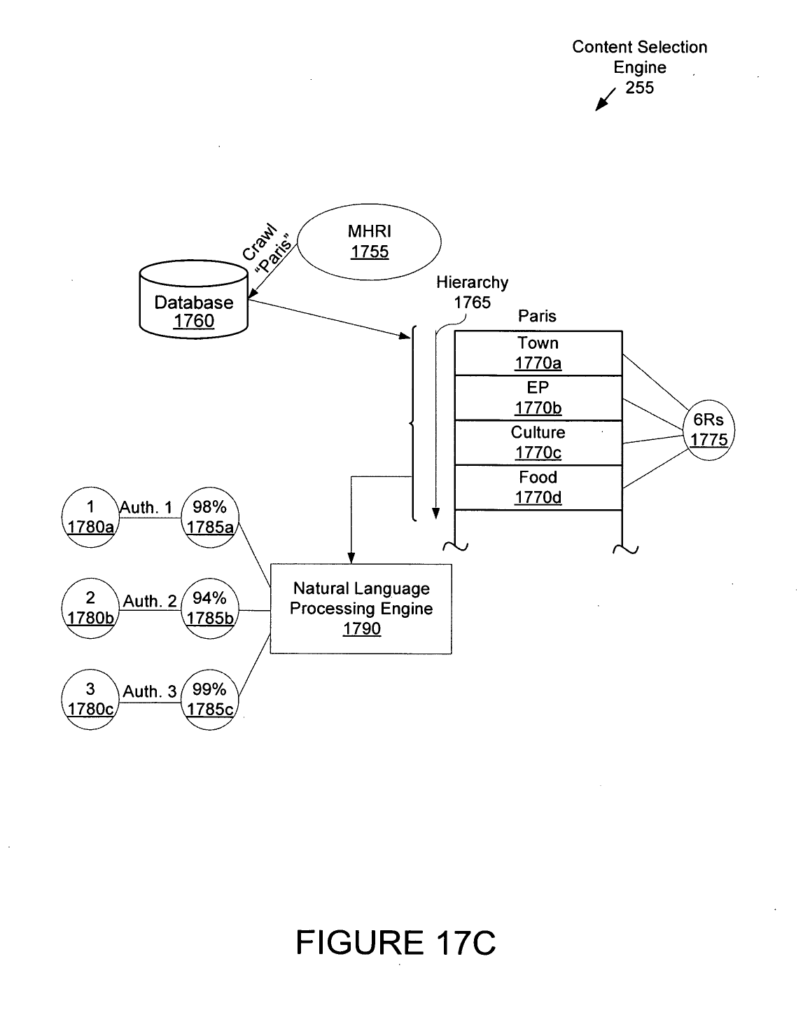

FIG. 17a is a diagram illustrating a content selection method 1700 in some embodiments. GUI 1702 receives a search request. At 1704, the content selection engine 255 determines if the MHRI 175 contains one or more DCNs 605 and content elements 105 to respond to the search (i.e., does a crawl request need to be made). If there is one or more DCNs 605 and there are content elements, then no request is needed (RequestData=“0”). On this path, the content selection engine 255 obtains content elements 105 via the MHRI 175, generates scoring (including credibility scoring), evaluates site ratings, and decides at step 1718 whether content elements 105 are of predicted interest to send to the user 115.

If the system determines that there are no DCNs 605 and/or insufficient content elements 105 in the MHRI 175, then the infuser 205 will initiate crawling (RequestData=“1”). The infused crawler 210 in step 1706 will locate new content elements 105 from a computer network 110 (such as the internet). Further, the content selection engine 255 will generate scoring (including credibility scoring), ensure that the scorings pass selection vector minimum thresholds (otherwise the content elements 105 may be discarded), evaluate site ratings, and decide at step 1718 whether any of the remaining content elements 105 are of predicted interest to the user 115. Also, after determining that the scorings pass selection vector minimum thresholds, the knowledge management engine 240 stores and indexes the new content elements 105 in the MHRI 175.

In some embodiments, a “low trends” function may compare credibility of data from sites associated with the R-D- in the site rating 1716. If the credibility of data from the site is low and the site is not in a top-10 topic trend (as far as the overall site is concerned) for a predetermined period of time (e.g., 10 consecutive weeks), the site and/or related content may be removed (e.g., permanently) from the MHRI.

FIG. 17b is a diagram illustrating a content selection method 1740 in some embodiments. Method 1700 begins with the infuser 205 in step 1742 preprocessing a string (e.g., a string generated from an express search or a dynamic search request). The content selection engine 255, possibly in cooperation with the infused crawler 210 and/or the knowledge management engine 240, in step 1744 searches the MHRI 175 to identify relevant content elements 105. The content selection engine 255, possibly in cooperation with the infused crawler 210 and/or the knowledge management engine 240, in step 1746 filters the relevant content elements 105 the user's PHRI 140 to identify the content elements 105 of probable interest to the user 115. The content selection engine 255, possibly in cooperation with the infused crawler 210 and/or the knowledge management engine 240, in step 1748 compares the user's matrix 150 with the author matrix 185 for each author 120 of each content element 105 of probable interest. The content selection engine 255, possibly in cooperation with the infused crawler 210 and/or the knowledge management engine 240, in step 1750 filters/sorts all content elements 105 according to the scores, and presents the list to the user 115.

FIG. 17c is a diagram illustrating additional details of the content selection engine in some embodiments. In various embodiments, the content selection engine retrieves content elements associated with “Paris” pursuant to an information request. The information request may be generated by the knowledge management engine based on personal information of a user. The information request may be generated based on a user request or, in another example, generated by assessing the user's personal information to determine a current AOI of the user.

In various embodiments, content elements associated with Paris may be retrieved from the MHRI 1755 and/or a communication network (e.g., via a infused crawl). The content elements may be stored in database 1760 for assessment. If the information request is general, a number of different content elements associated with different context may be retrieved. For example, content articles associated with Paris as a town 1770a, Paris' place in Europe 1770b, Paris culture 1770c, and food 1770d. those skilled in the art will appreciate that any number of associations may be retrieved based on the information request. The associations maybe in a hierarchy 1765 or in any order.

In various embodiments, natural language processing engine 1790 may assess each article to break down language and identify sentiment, intent, depth, context, or the like. Utilizing the information, the 6Rs 1775 may be retrieved (if previously stored in association with the MHRI 1755 or determined as discussed herein). Utilizing the 6Rs 1775 and/or other information associated with content elements, a credibility scores for each content element may be generated.

In various embodiments, authors may be matched with an interested user to find content that is likely to be of interest to the user. Authors may be identified for each content element. In the example in FIG. 17C, three authors are identified. In various embodiments, one or more AOE(s) and/or AOI(s) of the author are matched to one or more AOE(s) and/or AOI(s) of the user. In various embodiments, content published by the article is assessed to associate author characteristics (e.g., the author's general intent, depth, or the like as a function of content produced for a particular shared AOE and/or AOI with the user). Further, 6Rs of content produced for a particular shared AOE and/or AOI with the user may be assessed to further characterize the author and compare these qualities (e.g., characteristics) for a match of interest to the user. The degree of author/user match for authors 1, 2, and 3 is 1785a (98%), 1785b (94%), and 1785c (99%), respectively. As such, the authors may be re-ordered such that author 3 may be the best match at 1780c, followed by author 1 at 1780a, and then author 2 at 1780b. Articles regarding Paris that meet credibility scores and from Author 3 may be provided to the user.

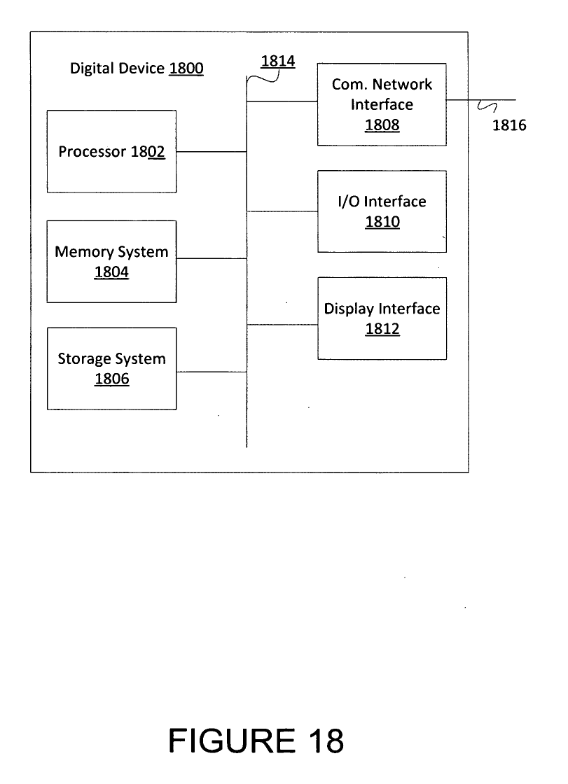

FIG. 18 depicts an exemplary digital device 1000 according to some embodiments. The digital device 1000 comprises a processor 1002, a memory system 1004, a storage system 1006, a communication network interface 1008, an I/O interface 1010, and a display interface 1012 communicatively coupled to a bus 1014. The processor 1002 may be configured to execute executable instructions (e.g., programs). In some embodiments, the processor 1002 comprises circuitry or any processor capable of processing the executable instructions.

The memory system 1004 is any memory configured to store data. Some examples of the memory system 1004 are storage devices, such as RAM or ROM. The memory system 1004 may comprise the RAM cache. In various embodiments, data is stored within the memory system 1004. The data within the memory system 1004 may be cleared or ultimately transferred to the storage system 1006.

The storage system 1006 is any storage configured to retrieve and store data. Some examples of the storage system 1006 are flash drives, hard drives, optical drives, and/or magnetic tape. In some embodiments, the digital device 1000 includes a memory system 1004 in the form of RAM and a storage system 1006 in the form of flash data. Both the memory system 1004 and the storage system 1006 comprise computer readable media which may store instructions or programs that are executable by a computer processor including the processor 1002.

The communication network interface (com. network interface) 1008 may be coupled to a data network (e.g., communication network 106) via a link. The communication network interface 1008 may support communication over an Ethernet connection, a serial connection, a parallel connection, or an ATA connection, for example. The communication network interface 1008 may also support wireless communication (e.g., 802.11a/b/g/n, WiMAX). It will be apparent to those skilled in the art that the communication network interface 1008 may support many wired and wireless standards.

The optional input/output (I/O) interface 1010 is any device that receives input from the user and output data. The optional display interface 1012 is any device that may be configured to output graphics and data to a display. In one example, the display interface 1012 is a graphics adapter.

It will be appreciated by those skilled in the art that the hardware elements of the digital device 1000 are not limited to those depicted. A digital device 1000 may comprise more or less hardware elements than those depicted. Further, hardware elements may share functionality and still be within various embodiments described herein. In one example, encoding and/or decoding may be performed by the processor 1002 and/or a co-processor located on a GPU.

The above-described functions and components may be comprised of instructions that are stored on a storage medium such as a non-transitive computer readable medium. The instructions may be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with some embodiments. Those skilled in the art are familiar with instructions, processor(s), and storage medium.

One skilled in the art will recognize that the digital device 1800 may also include additional information, such as network connections, additional memory, additional processors, LANs, input/output lines for transferring information across a hardware channel, the Internet or an intranet, etc. One skilled in the art will also recognize that the programs and data may be received by and stored in the digital device 1800 in alternative ways. For example, a computer-readable storage medium (CRSM) reader such as a magnetic disk drive, hard disk drive, magneto-optical reader, CPU, etc. may be coupled to the communications bus for reading a computer-readable storage medium (CRSM) such as a magnetic disk, a hard disk, a magneto-optical disk, RAM, etc. Accordingly, the digital device 1800 may receive programs and/or data via the CRSM reader. Further, it will be appreciated that the term “memory” herein is intended to cover all data storage media whether permanent or temporary.

In certain embodiments, the discovery system 130 may support the discovery of individuals or brands, such as authors, political figures, public figures, possible friends, etc.

Although the discovery system 130 herein is, in various locations, described as delivering content elements 105 to a user 115, one skilled in the art will recognize that any size discovery can be provided, e.g., the content element 105, the source document containing the content element 105 (e.g., the article in which the content element 105 was found), the section of the source document containing the content element 105, a set of content elements 105 located in one or more sources, or the like.

The foregoing description of the preferred embodiments of the present invention is by way of example only, and other variations and modifications of the above-described embodiments and methods are possible in light of the foregoing teaching. Although the network sites are being described as separate and distinct sites, one skilled in the art will recognize that these sites may be a part of an integral site, may each include portions of multiple sites, or may include combinations of single and multiple sites. The various embodiments set forth herein may be implemented utilizing hardware, software, or any desired combination thereof. For that matter, any type of logic may be utilized which is capable of implementing the various functionality set forth herein. Components may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

1. A system comprising:
a communication interface configured to receive personal information of a user;
a user characterization engine configured to determine a user interest of the user based on at least some of the personal information;
an infuser configured to generate a search string based on the user interest;
an infused crawler configured to retrieve one or more content elements from a network based on the search string;
a content characterization engine configured to assess a credibility score for each of the one or more content elements;
a content selection engine configured to determine a probability score of each of the one or more content elements, the probability score defining a predicted interest of the user for each of the one or more content elements, each probability score being based on the user interest and the respective credibility score of each of the one or more content elements; and
a content delivery engine configured to provide at least one of the one or more content elements to the user based on the one or more probability scores.

2. The system of claim 1, wherein the personal information includes private user data to which the user granted the system access.

3. The system of claim 1, wherein the content characterization engine assesses the credibility score of each of the one or more content elements by evaluating how other users responded to each of one or more content elements.

4. The system of claim 1, further comprising a knowledge management engine configured to store the user interest in a user profile for the user.

5. The system of claim 1, further comprising a knowledge management engine configured to store in a master profile information of the user interest, the one or more content elements, and the one or more credibility scores.

6. The system of claim 5, further comprising
an author discovery and attribution engine configured to attribute an author to each of the one or more retrieved content elements; and
an author characterization engine configured to determine a credibility score of each author as to the user interest;
wherein the knowledge management engine is further configured to store the author credibility score of each author in the master profile.

7. The system of claim 1, wherein the content selection engine determines the probability score by comparing sentiment, intention and/or depth of each of the retrieved one or more content elements against sentiment, intention and/or depth of the user as related to the user interest.

8. The system of claim 1, wherein the content selection engine determines the probability score by comparing author information about each author of the retrieved one or more content elements against user information about the user.

9. The system of claim 1, further comprising a content decomposition engine configured to decompose web data into the one or more content elements based on author attribution.

10. A method comprising:
receiving personal information of a user;
determining a user interest of the user based on at least some of the personal information;
generating a search string based on the user interest;
retrieving one or more content elements from a network based on the search string;
assessing a credibility score for each of the one or more content elements;
determining a probability score of each of the one or more content elements, the probability score defining a predicted interest of the user for each of the one or more content elements, each probability score being based on the user interest and the respective credibility score of each of the one or more content elements; and
providing at least one of the one or more content elements to the user based on the one or more probability scores.

11. The method of claim 10, wherein the personal information includes private user data to which the user granted the system access.

12. The method of claim 10, wherein the assessing the credibility score of each of the one or more content elements includes evaluating how other users responded to each of one or more content elements.

13. The method of claim 10, further comprising storing the user interest in a user profile for the user.

14. The method of claim 10, further comprising storing information on the user interest, the one or more content elements, and the one or more credibility scores in a master profile.

15. The method of claim 14, further comprising
attributing an author to each of the one or more retrieved content elements;
determining a credibility score of each author as to the user interest; and
storing the author credibility score of each author in the master profile.

16. The method of claim 10, wherein the determining the probability score includes comparing sentiment, intention and/or depth of each of the retrieved one or more content elements against sentiment, intention and/or depth of the user as related to the user interest.

17. The method of claim 10, wherein the determining the probability score includes comparing author information about each author of the retrieved one or more content elements against user information about the user.

18. The method of claim 10, further comprising decomposing a web site into the one or more content elements based on author attribution.

19. A system comprising:
means for receiving personal information of a user;
means for determining a user interest of the user based on at least some of the personal information;
means for generating a search string based on the user interest;
means for retrieving one or more content elements from a network based on the search string;
means for assessing a credibility score for each of the one or more content elements;
means for determining a probability score of each of the one or more content elements, the probability score defining a predicted interest of the user for each of the one or more content elements, each probability score being based on the user interest and the respective credibility score of each of the one or more content elements; and
means for providing at least one of the one or more content elements to the user based on the one or more probability scores.

20. A non-transitory computer-readable medium storing instructions executable by a processor to perform a method, the method comprising:
receiving personal information of a user;
determining a user interest of the user based on at least some of the personal information;
generating a search string based on the user interest;
retrieving one or more content elements from a network based on the search string;
assessing a credibility score for each of the one or more content elements;
determining a probability score of each of the one or more content elements, the probability score defining a predicted interest of the user for each of the one or more content elements, each probability score being based on the user interest and the respective credibility score of each of the one or more content elements; and
providing at least one of the one or more content elements to the user based on the one or more probability scores.
